(19) United States
(12) Patent Application Publication
(10) Pub. No.: US 2024/0337812 A1
(43) Pub. Date: Oct. 10, 2024

(54) ADJUSTABLE-FOCUS OPTICAL ASSEMBLIES FOR IMAGE CAPTURE DEVICES

(71) Applicant: GoPro, Inc., San Mateo, CA (US)

(72) Inventors: Mahshad Mosayebi, Palo Alto, CA (US); Jonathan Stern, San Mateo, CA (US); Peiqian Zhao, Mountain View, CA (US); Ian Copeland Griggs, San Francisco, CA (US); David Thomas Platner, San Francisco, CA (US)

(21) Appl. No.: 18/132,643

(22) Filed: Apr. 10, 2023

(51) Int. Cl. G02B 7/10; G02B 7/02; G03B 13/32

(52) U.S. Cl. CPC G02B 7/102; G02B 7/021; G02B 7/022; G03B 13/32

(57) ABSTRACT

An optical assembly for an image capture device that defines an optical axis and includes an optical module having: a lens holder; a first optical group supported by the lens holder; a lens barrel axially movable in relation to the lens holder along the optical axis; a second optical group supported by the lens barrel such that the second optical group is axially movable in relation to the first optical group along the optical axis to thereby adjust focus of the image capture device; and an adjustment member in engagement with the lens barrel such that rotation of the adjustment member causes axial movement of the lens barrel and the second optical group along the optical axis. In various embodiments, the adjustment member may be configured for rotation about an axis of rotation that extends in (generally) parallel relation or in (generally) orthogonal relation to the optical axis.

### TECHNICAL FIELD

The present disclosure relates to optical assemblies for image capture devices that include a focus adjustment mechanism that allows for image capture across a wider range of distance.

### BACKGROUND

Image capture devices are used in a variety of applications, such as, for example, handheld cameras and video recorders, cell phones, drones, vehicles, etc. In general, an optical assembly in an image capture device includes a variety of optical groups (e.g., one or more lenses or other such optical elements), which capture content by receiving and focusing light, and one or more image sensors, which convert the captured content into an electronic image signal that is processed by an image signal processor to form an image. In some image capture devices, the image sensor(s) are combined with one or more of the optical elements into a single unit, which is known as an integrated sensor-lens assembly (ISLA).

In order to improve the user experience and create additional options for image capture, the present disclosure describes optical assemblies that include a variety of focus adjustment mechanisms, each of which allows a user to (manually or automatically) adjust focus and capture objects across a wider range of distance.

### SUMMARY

In one aspect of the present disclosure, an optical assembly is disclosed for an image capture device that defines an optical axis and includes a first optical module and a second optical module. The first optical module includes: a first lens holder; a first lens barrel that is fixed in relation to the first lens holder; and a first optical group that is supported by the first lens barrel. The second optical module includes: a second lens holder; a second optical group that is supported by the second lens holder; a second lens barrel that is axially movable in relation to the second lens holder along the optical axis; and a third optical group that is supported by the second lens barrel such that the third optical group is axially movable in relation to the first optical group and the second optical group along the optical axis to thereby adjust focus of the image capture device.

In certain embodiments, the second lens holder and the second lens barrel may include corresponding anti-rotation features to inhibit rotation of the second lens barrel during focus adjustment.

In certain embodiments, the second optical module may further include an adjustment member that is in engagement with the second lens barrel such that such that rotation of the adjustment member causes axial movement of the second lens barrel and the third optical group along the optical axis.

In certain embodiments, the adjustment member may be configured for rotation about the optical axis.

In certain embodiments, the adjustment member and the second lens barrel may be threadably engaged.

In certain embodiments, the adjustment member may engage the second lens holder such that the second lens holder inhibits axial movement of the adjustment member along the optical axis during focus adjustment.

In certain embodiments, the second optical module may further include an adjustment member that extends through the second lens holder and into engagement with the second lens barrel such that rotation of the adjustment member causes axial movement of the second lens barrel and the third optical group along the optical axis.

In certain embodiments, the second lens holder may include an outer wall that defines an opening and a first guide channel.

In certain embodiments, the adjustment member may include a pin that extends into the first guide channel such that rotation of the adjustment member causes movement of the pin through the first guide channel.

In certain embodiments, the adjustment member may further include a tactile member and a support shaft.

In certain embodiments, the tactile member may be configured for manual engagement by a user and may support the pin such that the pin extends radially inward therefrom.

In certain embodiments, the support shaft may extend radially inward from the tactile member and into the opening defined by the outer wall of the second lens holder.

In certain embodiments, the support shaft may engage the second lens holder in a snap fit to secure the adjustment member within the second lens holder and facilitate rotation of the adjustment member in relation thereto.

In certain embodiments, the second lens barrel may include an outer wall that defines a second guide channel.

In certain embodiments, the pin may extend through the first guide channel and into the second guide channel such that rotation of the adjustment member causes movement of the pin through the second guide channel.

In another aspect of the present disclosure, an optical assembly is disclosed for an image capture device that defines an optical axis and includes an optical module having: a lens holder; a first optical group that is supported by the lens holder; a lens barrel that is axially movable in relation to the lens holder along the optical axis; a second optical group that is supported by the lens barrel such that the second optical group is axially movable in relation to the first optical group along the optical axis to thereby adjust focus of the image capture device; and an adjustment member that is in engagement with the lens barrel such that rotation of the adjustment member causes axial movement of the lens barrel and the second optical group along the optical axis, wherein the adjustment member is configured for rotation about an axis of rotation that extends in generally parallel relation to the optical axis.

In certain embodiments, the lens holder and the lens barrel may include corresponding anti-rotation features to inhibit rotation of the lens barrel during focus adjustment.

In certain embodiments, the adjustment member may threadably engage the lens barrel via corresponding threaded portions.

In certain embodiments, the adjustment member may be positioned in concentric relation to the lens barrel.

In certain embodiments, the lens holder may define a channel and the adjustment member may define a radial flange that extends into the channel such that the lens holder inhibits axial movement of the adjustment member along the optical axis during focus adjustment.

In certain embodiments, the optical module may further include a locking member that extends into the adjustment member.

In certain embodiments, the locking member may be selectively engageable with the lens barrel to inhibit axial movement thereof along the optical axis.

In another aspect of the present disclosure, an optical assembly is disclosed for an image capture device that defines an optical axis and includes an optical module having: a lens holder; a first optical group that is supported by the lens holder; a lens barrel that is axially movable in relation to the lens holder along the optical axis; a second optical group that is supported by the lens barrel such that the second optical group is axially movable in relation to the first optical group along the optical axis to thereby adjust focus of the image capture device; and an adjustment member that is in engagement with the lens barrel such that rotation of the adjustment member causes axial movement of the lens barrel and the second optical group along the optical axis, wherein the adjustment member is configured for rotation about an axis of rotation that extends in generally orthogonal relation to the optical axis.

In certain embodiments, the adjustment member may extend into a first guide channel that is defined by an outer wall of the lens holder such that rotation of the adjustment member causes movement of the adjustment member through the first guide channel.

In certain embodiments, the adjustment member may extend through the first guide channel and into a second guide channel that is defined by an outer wall of the lens barrel such that rotation of the adjustment member causes movement of the adjustment member through the second guide channel, whereby the lens barrel and the second optical group are displaced along the optical axis.

In certain embodiments, the second guide channel may be oriented in generally orthogonal relation to the optical axis.

In certain embodiments, the adjustment member may include a pin and a support shaft that extends in generally parallel relation to the pin.

In certain embodiments, the pin may extend into the first guide channel and the second guide channel.

In certain embodiments, the support shaft may extend into an opening that is defined by the outer wall of the lens holder such that the adjustment member is rotatable in relation thereto.

### BRIEF DESCRIPTION OF THE DRAWINGS

The present disclosure is best understood from the following detailed description when read in conjunction with the accompanying drawings. According to common practice, the various features of the drawings may not be to-scale, and the dimensions of the various features may be arbitrarily expanded or reduced. Additionally, in the interest of clarity, certain components, elements, and/or features may be omitted from certain drawings in the interest of clarity.

FIGS. 1A-B are isometric views of an example of an image capture device.

FIGS. 2A-B are isometric views of another example of an image capture device.

FIG. 3 is a block diagram of electronic components of an image capture device.

FIG. 4 is a front, perspective view of another example of an image capture device including an optical assembly with a (first) optical module and a (second) optical module according to the principles of the present disclosure.

FIG. 5 is a cross-sectional view of the optical assembly included in the image capture device seen in FIG. 4 and illustrating the (first) optical module and the (second) optical module.

FIG. 6 is a cross-sectional view of the (second) optical module seen in FIG. 5 according to one embodiment of the present disclosure.

FIG. 7 is a side, perspective view of the (second) optical module seen in FIG. 5 shown with parts separated.

FIG. 8 is a top, plan view of the image capture device seen in FIG. 4 shown with the (second) optical module seen in FIG. 5 separated therefrom.

FIG. 9 is a cross-sectional view of the (second) optical module seen in FIG. 5 shown in a (first) short-range configuration.

FIG. 10 is a cross-sectional view of the (second) optical module seen in FIG. 5 shown in a (second, infinity) long-range configuration.

FIG. 11 is a cross-sectional view of the (second) optical module seen in FIG. 5 according to one embodiment of the present disclosure.

FIG. 12 is a partial, cross-sectional view of the (second) optical module seen in FIG. 5 shown with parts separated.

FIG. 13 is a partial, front, perspective view of the (second) optical module seen in FIG. 5.

FIG. 14 is a cross-sectional view of an alternate embodiment of the optical assembly seen in FIG. 5, which includes the (first) optical module seen in FIG. 5 and a (second) optical module.

FIG. 15 is a side, perspective view of the (second) optical module seen in FIG. 14.

FIG. 16 is a side, perspective view of a lens holder of the (second) optical module seen in FIG. 15.

FIG. 17 is a side, perspective view of a lens barrel of the (second) optical module seen in FIG. 15.

FIG. 18 is a partial, side, perspective view of the (second) optical module seen in FIG. 15 with the lens holder and an adjustment member shown in phantom.

FIG. 19 is a top, plan view of the image capture device seen FIG. 4 shown with the (second) optical module seen in FIG. 15 separated therefrom.

FIG. 20 is a side, plan view of the adjustment member of the (second) optical module seen in FIG. 15.

FIG. 21 is an end, plan view of the adjustment member seen in FIG. 20.

FIG. 22 is a partial, side, perspective view of the (second) optical module seen in FIG. 15 (with the lens holder shown in phantom).

FIG. 23 is a partial, side, perspective view of the (second) optical module seen in FIG. 15 illustrating the lens holder and the adjustment member.

FIG. 24 is a partial, cross-sectional view of the (second) optical module taken along line 24-24 in FIG. 15.

FIG. 25 is a side, perspective view of the (second) optical module seen in FIG. 15 shown in a (first, infinity) long-range configuration.

FIG. 26 is a perspective, cross-sectional view of the (second) optical module seen in FIG. 15 taken along line 26-26 in FIG. 25.

FIG. 27 is a side, perspective view of the (second) optical module seen in FIG. 15 shown in a (second) short-range configuration.

FIG. 28 is a perspective, cross-sectional view of the (second) optical module seen in FIG. 15 taken along line 28-28 in FIG. 27.

FIG. 29 is a side, perspective view of the (second) optical module seen in FIG. 15 according to one embodiment of the present disclosure.

### DETAILED DESCRIPTION

The present disclosure describes various embodiments of an adjustable-focus optical assembly for an image capture device that allows the image capture device to focus on objects across a wider range of distance. More specifically, the optical assemblies described herein include a focus adjustment mechanism that converts rotatory motion into linear motion in order to vary spacing between optical groups in the optical assembly and thereby adjust focus of image capture device.

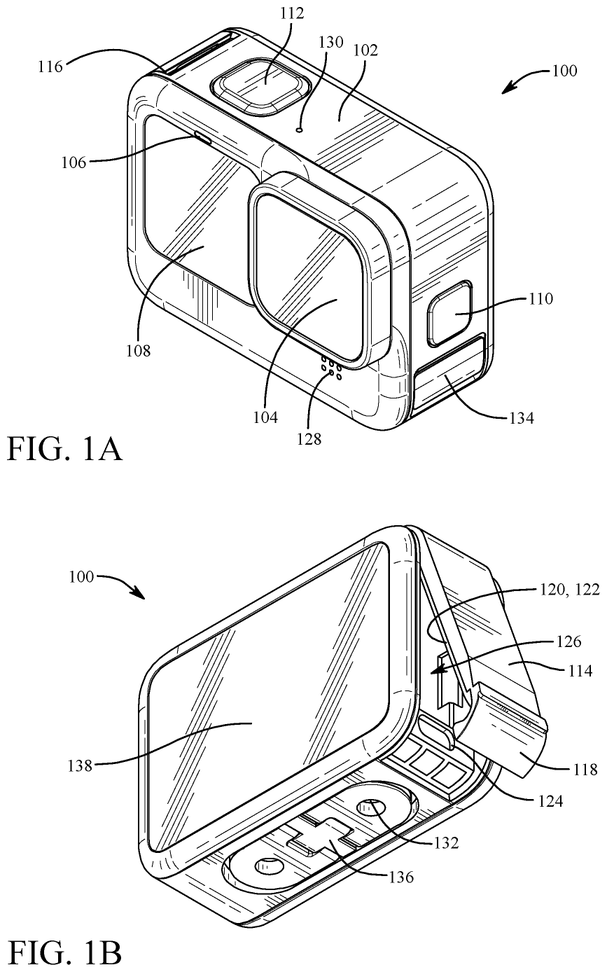

FIGS. 1A-B are isometric views of an example of an image capture device 100. The image capture device 100 may include a body 102, one or more lenses 104 structured on a front surface of the body 102, various indicators on the front surface of the body 102 (such as light-emitting diodes (LEDs), displays, and the like), various input mechanisms (such as buttons, switches, and/or touch-screens), and electronics (such as imaging electronics, power electronics, etc.) internal to the body 102 for capturing images via the lens(es) 104 and/or performing other functions. The lens(es) 104 receive light incident upon the lens(es) 104 and to direct received light onto an image sensor internal to the body 102, as described in further detail below. The image capture device 100 may be configured to capture images and video and to store captured images and video for subsequent display or playback.

The image capture device 100 may include an LED or another form of indicator 106 to indicate a status of the image capture device 100 and a liquid-crystal display (LCD) or other form of a display 108 to show status information such as battery life, camera mode, elapsed time, and the like. The image capture device 100 may also include a mode button 110 and a shutter button 112 that are configured to allow a user of the image capture device 100 to interact with the image capture device 100. For example, the mode button 110 and the shutter button 112 may be used to turn the image capture device 100 on and off, scroll through modes and settings, and select modes and change settings. The image capture device 100 may include additional buttons or interfaces (not shown) to support and/or control additional functionality.

The image capture device 100 may include a door 114 coupled to the body 102, for example, using a hinge mechanism 116. The door 114 may be secured to the body 102 using a latch mechanism 118 that releasably engages the body 102 at a position generally opposite the hinge mechanism 116. The door 114 may also include a seal 120 and a battery interface 122. When the door 114 is an open position, access is provided to an input-output (I/O) interface 124 for connecting to or communicating with external devices as described below and to a battery receptacle 126 for placement and replacement of a battery (not shown). The battery receptacle 126 includes operative connections (not shown) for power transfer between the battery and the image capture device 100. When the door 114 is in a closed position, the seal 120 engages a flange (not shown) or other interface to provide an environmental seal, and the battery interface 122 engages the battery to secure the battery in the battery receptacle 126. The door 114 can also have a removed position (not shown) where the entire door 114 is separated from the image capture device 100, that is, where both the hinge mechanism 116 and the latch mechanism 118 are decoupled from the body 102 to allow the door 114 to be removed from the image capture device 100.

The image capture device 100 may include a microphone 128 (or speaker) on a front surface and another microphone 130 on a top surface. The image capture device 100 may include other microphones on other surfaces (not shown). The microphones 128, 130 may be configured to receive and record audio signals in conjunction with recording video or separate from recording of video. The image capture device 100 may include a speaker 132 on a bottom surface of the image capture device 100. The image capture device 100 may include other speakers on other surfaces (not shown). The speaker 132 may be configured to play back recorded audio or emit sounds associated with notifications.

A side surface of the image capture device 100 may include a drainage channel 134. The drainage channel 134 may remove moisture from another microphone and/or speaker (not shown). A bottom surface of the image capture device 100 may include an interconnect mechanism 136 for connecting the image capture device 100 to a handle grip or other securing device. In the example shown in FIG. 1B, the interconnect mechanism 136 includes folding protrusions configured to move between a nested or collapsed position (shown) and an extended or open position (not shown) that facilitates coupling of the protrusions to mating protrusions of other devices such as handle grips, mounts, clips, or like devices.

The image capture device 100 may include an interactive display 138 that allows for interaction with the image capture device 100 while simultaneously displaying information on a surface of the image capture device 100.

The image capture device 100 of FIGS. 1A-B includes an exterior that encompasses and protects internal electronics. In the present example, the exterior includes six surfaces (i.e., a front face, a left face, a right face, a back face, a top face, and a bottom face) that form a rectangular cuboid. Furthermore, both the front and rear surfaces of the image capture device 100 are rectangular. In other embodiments, the exterior may have a different shape. The image capture device 100 may be made of a rigid material such as plastic, aluminum, steel, or fiberglass. The image capture device 100 may include features other than those described here. For example, the image capture device 100 may include additional buttons or different interface features, such as interchangeable lenses, cold shoes, and hot shoes that can add functional features to the image capture device 100.

The image capture device 100 may include various types of image sensors, such as charge-coupled device (CCD) sensors, active pixel sensors (APS), complementary metal-oxide-semiconductor (CMOS) sensors, N-type metal-oxide-semiconductor (NMOS) sensors, and/or any other image sensor or combination of image sensors.

Although not illustrated, in various embodiments, the image capture device 100 may include other additional electrical components (e.g., an image processor, camera system-on-chip (SoC), etc.), which may be included on one or more circuit boards within the body 102 of the image capture device 100.

The image capture device 100 may interface with or communicate with an external device, such as an external user interface device (not shown), via a wired or wireless computing communication link (e.g., the I/O interface 124). Any number of computing communication links may be used. The computing communication link may be a direct computing communication link or an indirect computing communication link, such as a link including another device or a network, such as the internet, may be used.

In some implementations, the computing communication link may be a Wi-Fi link, an infrared link, a Bluetooth (BT) link, a cellular link, a ZigBee link, a near field communications (NFC) link, such as an ISO/IEC 20643 protocol link, an Advanced Network Technology interoperability (ANT+) link, and/or any other wireless communications link or combination of links.

In some implementations, the computing communication link may be an HDMI link, a USB link, a digital video interface link, a display port interface link, such as a Video Electronics Standards Association (VESA) digital display interface link, an Ethernet link, a Thunderbolt link, and/or other wired computing communication link.

The image capture device 100 may transmit images, such as panoramic images, or portions thereof, to the external user interface device via the computing communication link, and the external user interface device may store, process, display, or a combination thereof the panoramic images.

The external user interface device may be a computing device, such as a smartphone, a tablet computer, a phablet, a smart watch, a portable computer, personal computing device, and/or another device or combination of devices configured to receive user input, communicate information with the image capture device 100 via the computing communication link, or receive user input and communicate information with the image capture device 100 via the computing communication link.

The external user interface device may display, or otherwise present, content, such as images or video, acquired by the image capture device 100. For example, a display of the external user interface device may be a viewport into the three-dimensional space represented by the panoramic images or video captured or created by the image capture device 100.

The external user interface device may communicate information, such as metadata, to the image capture device 100. For example, the external user interface device may send orientation information of the external user interface device with respect to a defined coordinate system to the image capture device 100, such that the image capture device 100 may determine an orientation of the external user interface device relative to the image capture device 100.

Based on the determined orientation, the image capture device 100 may identify a portion of the panoramic images or video captured by the image capture device 100 for the image capture device 100 to send to the external user interface device for presentation as the viewport. In some implementations, based on the determined orientation, the image capture device 100 may determine the location of the external user interface device and/or the dimensions for viewing of a portion of the panoramic images or video.

The external user interface device may implement or execute one or more applications to manage or control the image capture device 100. For example, the external user interface device may include an application for controlling camera configuration, video acquisition, video display, or any other configurable or controllable aspect of the image capture device 100.

The user interface device, such as via an application, may generate and share, such as via a cloud-based or social media service, one or more images, or short video clips, such as in response to user input. In some implementations, the external user interface device, such as via an application, may remotely control the image capture device 100 such as in response to user input.

The external user interface device, such as via an application, may display unprocessed or minimally processed images or video captured by the image capture device 100 contemporaneously with capturing the images or video by the image capture device 100, such as for shot framing or live preview, and which may be performed in response to user input. In some implementations, the external user interface device, such as via an application, may mark one or more key moments contemporaneously with capturing the images or video by the image capture device 100, such as with a tag or highlight in response to a user input or user gesture.

The external user interface device, such as via an application, may display or otherwise present marks or tags associated with images or video, such as in response to user input. For example, marks may be presented in a camera roll application for location review and/or playback of video highlights.

The external user interface device, such as via an application, may wirelessly control camera software, hardware, or both. For example, the external user interface device may include a web-based graphical interface accessible by a user for selecting a live or previously recorded video stream from the image capture device 100 for display on the external user interface device.

The external user interface device may receive information indicating a user setting, such as an image resolution setting (e.g., 3840 pixels by 2160 pixels), a frame rate setting (e.g., 60 frames per second (fps)), a location setting, and/or a context setting, which may indicate an activity, such as mountain biking, in response to user input, and may communicate the settings, or related information, to the image capture device 100.

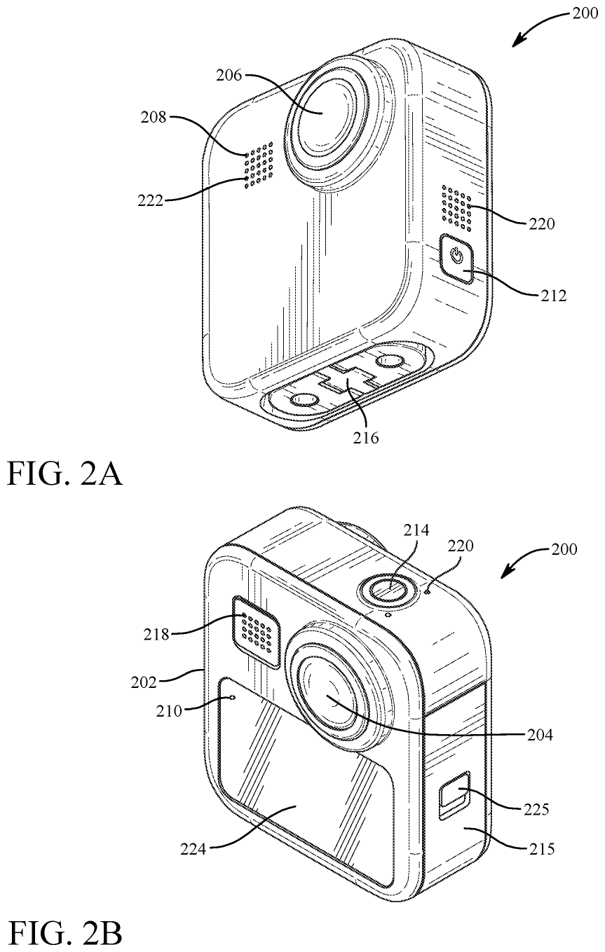

FIGS. 2A-B illustrate another example of an image capture device 200. The image capture device 200 includes a body 202 and two camera lenses 204 and 206 disposed on opposing surfaces of the body 202, for example, in a back-to-back configuration, Janus configuration, or offset Janus configuration. The body 202 of the image capture device 200 may be made of a rigid material such as plastic, aluminum, steel, or fiberglass.

The image capture device 200 includes various indicators on the front of the surface of the body 202 (such as LEDs, displays, and the like), various input mechanisms (such as buttons, switches, and touch-screen mechanisms), and electronics (e.g., imaging electronics, power electronics, etc.) internal to the body 202 that are configured to support image capture via the two camera lenses 204 and 206 and/or perform other imaging functions.

The image capture device 200 includes various indicators, for example, LEDs 208, 210 to indicate a status of the image capture device 100. The image capture device 200 may include a mode button 212 and a shutter button 214 configured to allow a user of the image capture device 200 to interact with the image capture device 200, to turn the image capture device 200 on, and to otherwise configure the operating mode of the image capture device 200. It should be appreciated, however, that, in alternate embodiments, the image capture device 200 may include additional buttons or inputs to support and/or control additional functionality.

The image capture device 200 may include an interconnect mechanism 216 for connecting the image capture device 200 to a handle grip or other securing device. In the example shown in FIGS. 2A and 2B, the interconnect mechanism 216 includes folding protrusions configured to move between a nested or collapsed position (not shown) and an extended or open position as shown that facilitates coupling of the protrusions to mating protrusions of other devices such as handle grips, mounts, clips, or like devices.

The image capture device 200 may include audio components 218, 220 such as microphones configured to receive and record audio signals (e.g., voice or other audio commands) in conjunction with recording video. The audio component 218, 220 can also be configured to play back audio signals or provide notifications or alerts, for example, using speakers. Placement of the audio components 218, 220, 222 may be on one or more of several surfaces of the image capture device 200. In the example of FIGS. 2A and 2B, the image capture device 200 includes three audio components 218, 220, 222, with the audio component 218 on a front surface, the audio component 220 on a top surface, and the audio component 222 on a back surface of the image capture device 200. Other numbers and configurations for the audio components are also possible.

The image capture device 200 may include an interactive display 224 that allows for interaction with the image capture device 200 while simultaneously displaying information on a surface of the image capture device 200. The interactive display 224 may include an I/O interface, receive touch inputs, display image information during video capture, and/or provide status information to a user. The status information provided by the interactive display 224 may include battery power level, memory card capacity, time elapsed for a recorded video, etc. The image capture device 200 may include a release mechanism 225 that receives a user input to in order to change a position of a door 215 of the image capture device 200. The release mechanism 225 may be used to open the door 215 in order to access a battery, a battery receptacle, an I/O interface, a memory card interface, etc. (not shown) that are similar to components described in respect to the image capture device 100 of FIGS. 1A and 1B.

In some embodiments, the image capture device 200 described herein includes features other than those described. For example, instead of the I/O interface and the interactive display 224, the image capture device 200 may include additional interfaces or different interface features. For example, the image capture device 200 may include additional buttons or different interface features, such as interchangeable lenses, cold shoes, and hot shoes that can add functional features to the image capture device 200.

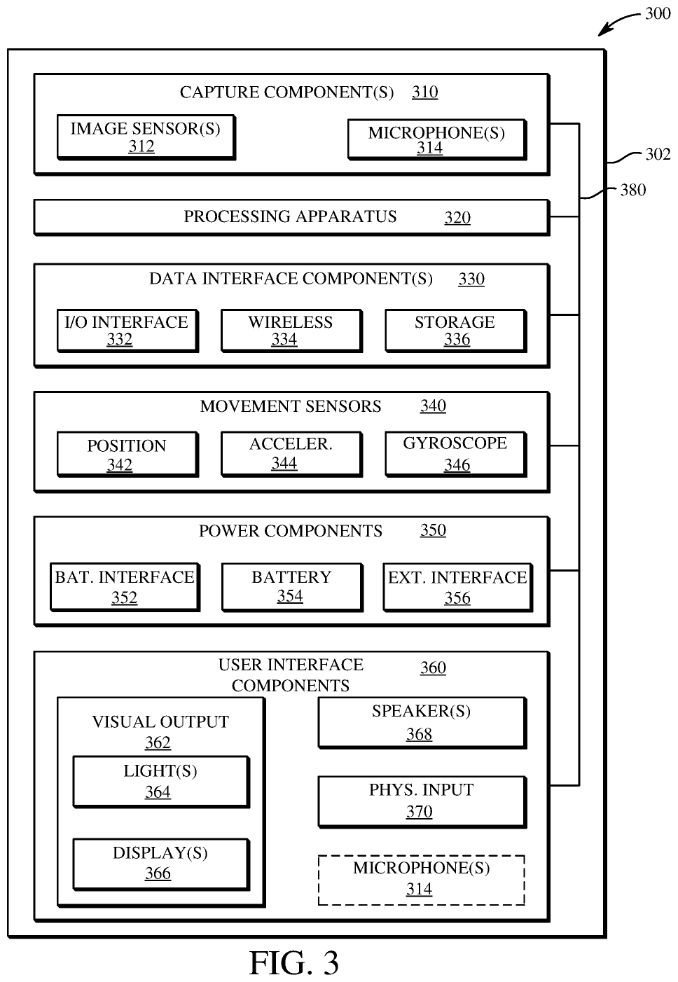

FIG. 3 is a block diagram of electronic components in an image capture device 300. The image capture device 300 may be a single-lens image capture device, a multi-lens image capture device, or variations thereof, including an image capture device with multiple capabilities such as use of interchangeable integrated sensor lens assemblies. The description of the image capture device 300 is also applicable to the image capture devices 100, 200 of FIGS. 1A-B and 2A-D.

The image capture device 300 includes a body 302 which includes electronic components such as capture components 310, a processing apparatus 320, data interface components 330, movement sensors 340, power components 350, and/or user interface components 360.

The capture components 310 include one or more image sensors 312 for capturing images and one or more microphones 314 for capturing audio.

The image sensor(s) 312 is configured to detect light of a certain spectrum (e.g., the visible spectrum or the infrared spectrum) and convey information constituting an image as electrical signals (e.g., analog or digital signals). The image sensor(s) 312 detects light incident through a lens coupled or connected to the body 302. The image sensor(s) 312 may be any suitable type of image sensor, such as a charge-coupled device (CCD) sensor, active pixel sensor (APS), complementary metal-oxide-semiconductor (CMOS) sensor, N-type metal-oxide-semiconductor (NMOS) sensor, and/or any other image sensor or combination of image sensors. Image signals from the image sensor(s) 312 may be passed to other electronic components of the image capture device 300 via a bus 380, such as to the processing apparatus 320. In some implementations, the image sensor(s) 312 includes a digital-to-analog converter. A multi-lens variation of the image capture device 300 can include multiple image sensors 312.

The microphone(s) 314 is configured to detect sound, which may be recorded in conjunction with capturing images to form a video. The microphone(s) 314 may also detect sound in order to receive audible commands to control the image capture device 300.

The processing apparatus 320 may be configured to perform image signal processing (e.g., filtering, tone mapping, stitching, and/or encoding) to generate output images based on image data from the image sensor(s) 312. The processing apparatus 320 may include one or more processors having single or multiple processing cores. In some implementations, the processing apparatus 320 may include an application specific integrated circuit (ASIC). For example, the processing apparatus 320 may include a custom image signal processor. The processing apparatus 320 may exchange data (e.g., image data) with other components of the image capture device 300, such as the image sensor(s) 312, via the bus 380.

The processing apparatus 320 may include memory, such as a random-access memory (RAM) device, flash memory, or another suitable type of storage device, such as a non-transitory computer-readable memory. The memory of the processing apparatus 320 may include executable instructions and data that can be accessed by one or more processors of the processing apparatus 320. For example, the processing apparatus 320 may include one or more dynamic random-access memory (DRAM) modules, such as double data rate synchronous dynamic random-access memory (DDR SDRAM). In some implementations, the processing apparatus 320 may include a digital signal processor (DSP). More than one processing apparatus may also be present or associated with the image capture device 300.

The data interface components 330 enable communication between the image capture device 300 and other electronic devices, such as a remote control, a smartphone, a tablet computer, a laptop computer, a desktop computer, or a storage device. For example, the data interface components 330 may be used to receive commands to operate the image capture device 300, transfer image data to other electronic devices, and/or transfer other signals or information to and from the image capture device 300. The data interface components 330 may be configured for wired and/or wireless communication. For example, the data interface components 330 may include an I/O interface 332 that provides wired communication for the image capture device, which may be a USB interface (e.g., USB type-C), a high-definition multimedia interface (HDMI), or a FireWire interface. The data interface components 330 may include a wireless data interface 334 that provides wireless communication for the image capture device 300, such as a Bluetooth interface, a ZigBee interface, and/or a Wi-Fi interface. The data interface components 330 may include a storage interface 336, such as a memory card slot configured to receive and operatively couple to a storage device (e.g., a memory card) for data transfer with the image capture device 300 (e.g., for storing captured images and/or recorded audio and video).

The movement sensors 340 may detect the position and movement of the image capture device 300. The movement sensors 340 may include a position sensor 342, an accelerometer 344, or a gyroscope 346. The position sensor 342, such as a global positioning system (GPS) sensor, is used to determine a position of the image capture device 300. The accelerometer 344, such as a three-axis accelerometer, measures linear motion (e.g., linear acceleration) of the image capture device 300. The gyroscope 346, such as a three-axis gyroscope, measures rotational motion (e.g., rate of rotation) of the image capture device 300. Other types of movement sensors 340 may also be present or associated with the image capture device 300.

The power components 350 may receive, store, and/or provide power for operating the image capture device 300. The power components 350 may include a battery interface 352 and a battery 354. The battery interface 352 operatively couples to the battery 354, for example, with conductive contacts to transfer power from the battery 354 to the other electronic components of the image capture device 300. The power components 350 may also include an external interface 356, and the power components 350 may, via the external interface 356, receive power from an external source, such as a wall plug or external battery, for operating the image capture device 300 and/or charging the battery 354 of the image capture device 300. In some implementations, the external interface 356 may be the I/O interface 332. In such an implementation, the I/O interface 332 may enable the power components 350 to receive power from an external source over a wired data interface component (e.g., a USB type-C cable).

The user interface components 360 may allow the user to interact with the image capture device 300, for example, providing outputs to the user and receiving inputs from the user. The user interface components 360 may include visual output components 362 to visually communicate information and/or present captured images to the user. The visual output components 362 may include one or more lights 364 and/or more displays 366. The display(s) 366 may be configured as a touch screen that receives inputs from the user. The user interface components 360 may also include one or more speakers 368. The speaker(s) 368 can function as an audio output component that audibly communicates information and/or presents recorded audio to the user. The user interface components 360 may also include one or more physical input interfaces 370 that are physically manipulated by the user to provide input to the image capture device 300. The physical input interfaces 370 may, for example, be configured as buttons, toggles, or switches. The user interface components 360 may also be considered to include the microphone(s) 314, as indicated in dotted line, and the microphone(s) 314 may function to receive audio inputs from the user, such as voice commands.

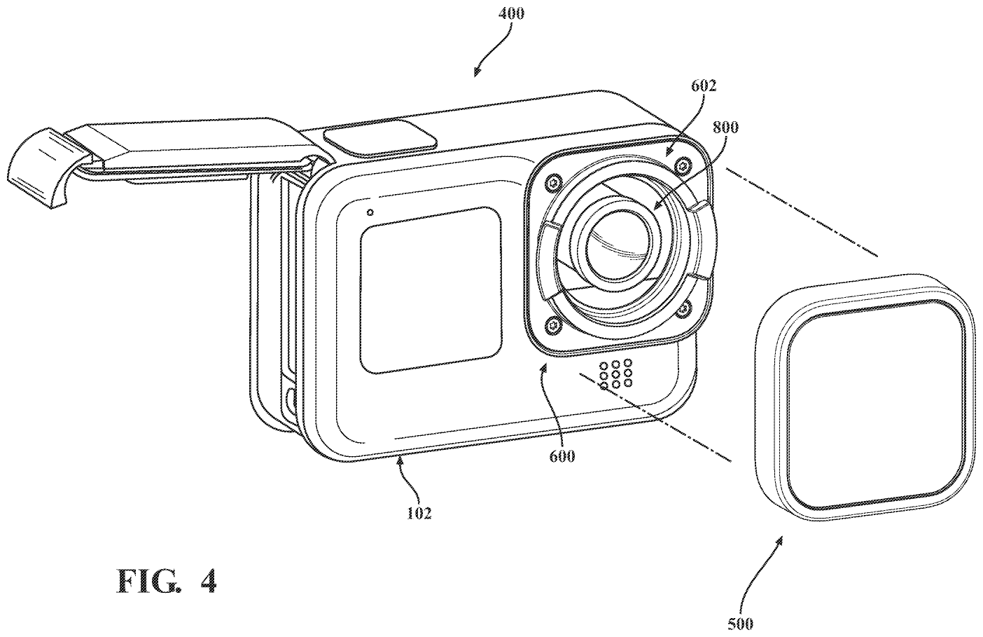

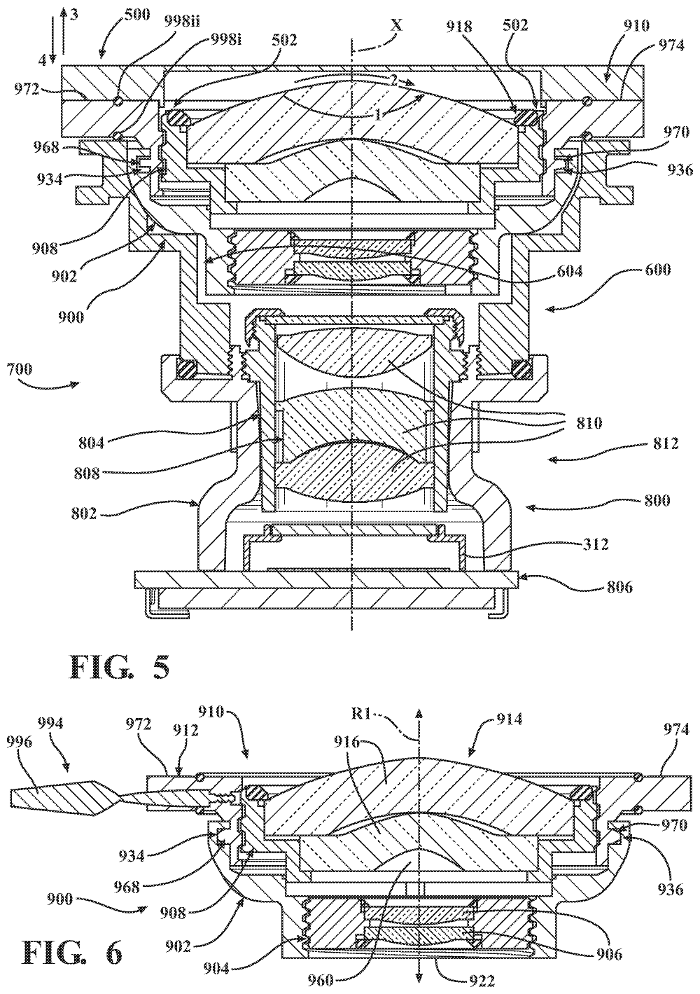

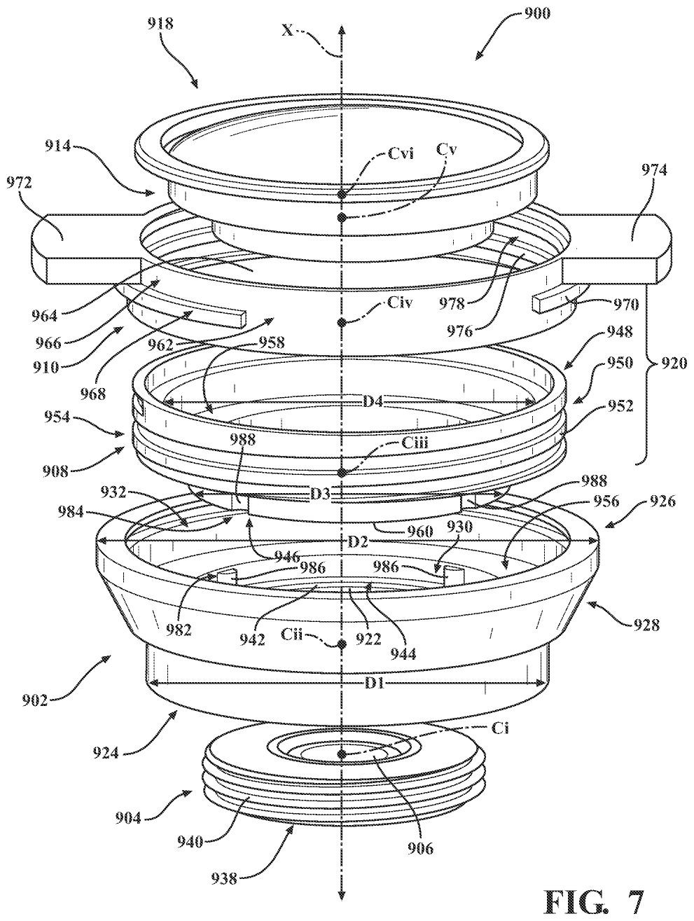

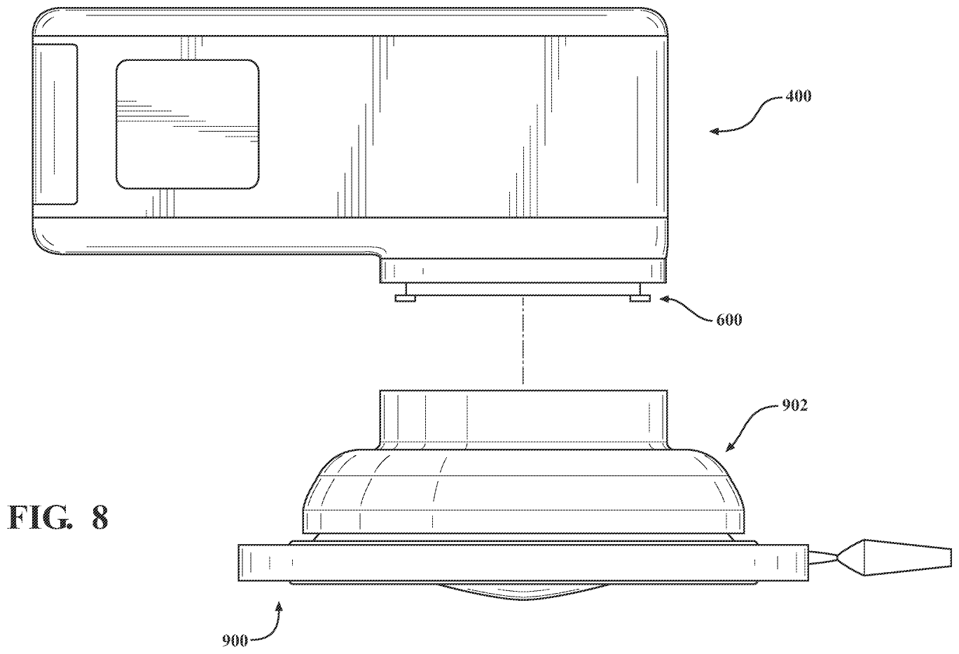

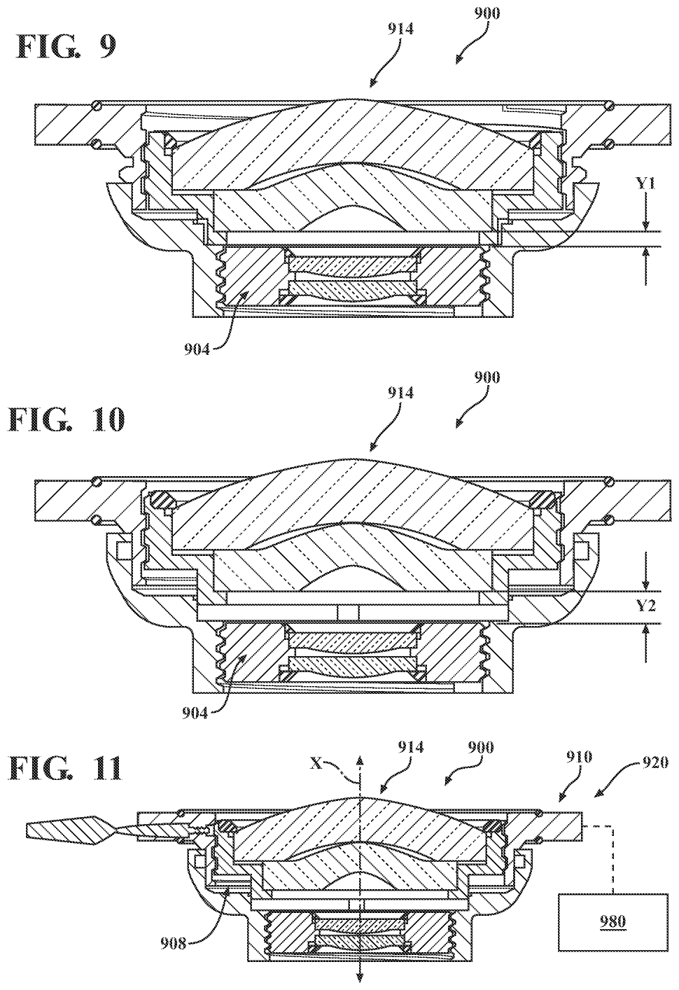

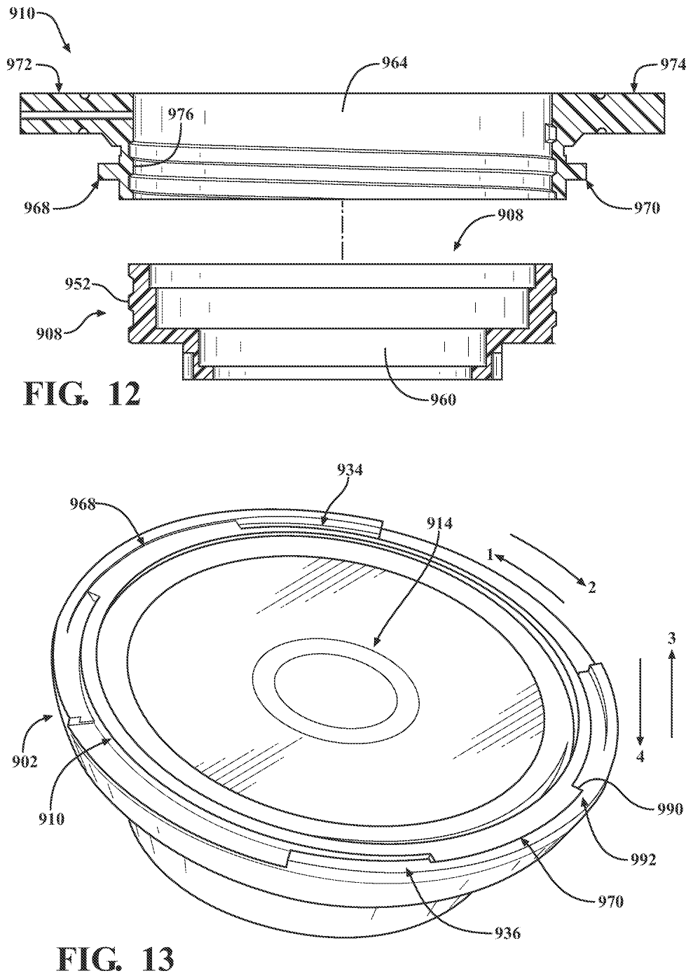

Referring now to FIGS. 4-13, an image capture device 400 is illustrated, which includes: a cover 500; a mounting member 600 (e.g., a bayonet 602), which supports the cover 500 and is connected (secured) to the body 102 of the image capture device 400; and an optical assembly 700, which includes a (first) optical module 800 and a (second) optical module 900. More specifically, FIG. 4 is a front, perspective view of the image capture device 400 with the cover 500 shown separated therefrom; FIG. 5 is a partial, cross-sectional view of the image capture device 400 illustrating the optical assembly 700 and the cover 500; FIG. 6 is a cross-sectional view of the optical module 900 according to an alternate embodiment of the present disclosure; FIG. 7 is a side, perspective view of the optical module 900 shown with parts separated; FIG. 8 is a top, plan view of the image capture device 400 with the optical module 900 shown separated therefrom; FIG. 9 is a cross-sectional view of the optical module 900 shown in a (first) short-range configuration; FIG. 10 is a cross-sectional view of the optical module 900 shown in a (second, infinity) long-range configuration; FIG. 11 is a cross-sectional view of the optical module 900 according to an alternate embodiment of the present disclosure; FIG. 12 is a partial, cross-sectional view of the optical module 900 shown with parts separated; and FIG. 13 is a partial, front, perspective view of the optical module 900. The image capture device 400 includes features similar to the aforedescribed image capture devices 100, 200, 300 and, accordingly, will only be discussed with respect to differences therefrom in the interest of brevity. As such, identical reference characters will be utilized to refer to elements, structures, features, etc., common to the image capture devices 100, 200, 300, 400.

The optical assembly 700 (FIG. 5) receives and focuses light and converts captured content into an electronic image signal that is processed to form an image. The optical assembly 700 (e.g., each of the optical modules 800, 900) is supported by (connected to) the mounting member 600 and defines an optical axis X, which extends through the optical module 800 and the optical module 900. In various embodiments of the present disclosure, it is envisioned that the optical assembly 700 may be either unitary or modular in construction. For example, embodiments are envisioned in which the optical modules 800, 900 may be fixedly (e.g., non-removably) connected together, either directly or indirectly (e.g., via the mounting member 600), so as to form a single, integrated unit, as are embodiments in which the optical modules 800, 900 may be releasably (e.g., removably) connected together, either directly or indirectly (e.g., via the mounting member 600), as described in further detail below.

The optical module 800 extends into the mounting member 600 and includes: a (first) lens holder (mount) 802; a (first) lens barrel 804, which is located within and is secured to the lens holder 802 such that the lens barrel 804 is fixed in relation thereto (e.g., via an adhesive connection and/or a mechanical connection); a printed circuit board (PCB) 806, which supports one or more image sensors (e.g., the image sensor(s) 312 (FIG. 3); and a (first, fixed) optical group 808, which is supported by the lens barrel 804 and receives and directs light onto the image sensor(s) 312 via one or more lenses 810 (or other such optical elements). As seen in FIG. 5, the PCB 806 and, thus, the image sensor(s) 312, is directly connected to the lens holder 802, whereby lens holder 802, the lens barrel 804, the image sensor(s) 312, and the optical group 808 are combined into a single unit (e.g., an ISLA 812).

With reference now to FIGS. 6-13 in particular, the optical module 900 will be discussed. The optical module 900 extends into the mounting member 600, as seen in FIG. 5, and includes: a (second) lens holder (mount) 902; a (second, inner, fixed) optical group 904, which includes one or more lenses 906 (or other such optical elements); a (second) lens barrel 908; an adjustment member 910 (e.g., an adjustment ring 912); a (third, outer, movable) optical group 914, which is supported by (e.g., secured, connected to) the lens barrel 908 and includes one or more lenses 916 (or other such optical elements); and a retainer 918. Collectively, the lens barrel 908 and the adjustment member 910 provide a focus adjustment mechanism 920 for the optical module 900 that allows the optical module 900 to focus on objects at various distances, as described in further detail below.

As seen in FIG. 7, the optical group 904, the lens holder 902, the lens barrel 908, the adjustment member 910, the optical group 914, and the retainer 918 define respective centerpoints Ci-Cvi and are arranged concentrically. More specifically, the optical group 904, the lens holder 902, the lens barrel 908, the adjustment member 910, the optical group 914, and the retainer 918 are configured such that the respective centerpoints Ci-Cvi thereof are aligned along the optical axis X.

The lens holder 902 supports each of the optical groups 904, 914, the lens barrel 908, the adjustment member 910, and the retainer 918, and defines a (central) aperture 922, which allows light received by the optical group 914 to pass through the lens holder 902 to the optical groups 904, 808 (FIG. 5). The lens holder 902 is configured for engagement (contact) with the mounting member 600 (FIGS. 4, 5) in either a fixed (non-removable) or a removable manner. For example, in certain embodiments of the present disclosure, it is envisioned that the lens holder 902 and the mounting member 600 may be configured for releasable engagement (connection) to allow for repeated connection and disconnection of the optical module 900 to the image capture device 400 and/or replacement of the optical module 900 with an alternate optical module having different optical qualities or features. In such embodiments of the present disclosure, it is envisioned that the optical module 900 may thus be provided as a standalone accessory for the image capture device 400 that can be utilized to incorporate the adjustable focus described herein below, as seen in FIG. 8.

As seen in FIG. 7, the lens holder 902 includes an inner (first) end 924, which defines a (first) transverse cross-sectional dimension D1 and is configured for insertion into the mounting member 600, and an outer (second) end 926, which defines a (second) transverse cross-sectional dimension D2. The transverse cross-sectional dimension D2 exceeds the transverse cross-sectional dimension D1, which attributes a stepped (or tapered) outer profile (contour) 928 to the lens holder 902 that corresponds to an inner profile (contour) 604 (FIG. 5) defined by mounting member 600, which facilitates assembly of the optical assembly 700 and reduces the overall dimensions thereof. The inner end 924 of the lens holder 902 defines an inner (first) chamber 930, which is configured to receive (accommodate) the optical group 904. The outer end 926 of the lens holder 902 defines an outer (second) chamber 932, which is configured to receive (accommodate) the lens barrel 908, the optical group 914, the adjustment member 910, and the retainer 918, as well as (radial) channels 934, 936 (FIGS. 5, 6) that extend outwardly (e.g., away from the optical axis X).

Although shown as including a pair of channels 934, 936 in the illustrated embodiment, it is envisioned that the particular number of channels 934, 936 may be altered in various embodiments without departing from the scope of the present disclosure (e.g., depending upon the particular configuration of the adjustment member 910). For example, an embodiment of the lens holder 902 including a single channel (e.g., the channel 934 or the channel 936) is also envisioned herein.

As indicated above, the optical group 904 is positioned (located, housed, accommodated) within (is received by) the lens holder 902 (e.g., the inner chamber 930) in concentric relation thereto and includes a housing 938, which supports the lens(es) 906. The housing 938 includes an (external) threaded portion 940 that is configured for engagement (contact) with an (internal) threaded portion 942 (FIG. 7) on an inner wall 944 of the lens holder 902 (e.g., within the inner chamber 930), which facilitates threaded engagement of the optical group 904 and the lens holder 902 during assembly of the optical assembly 700.

In the illustrated embodiment, the optical group 904 is fixedly connected to the lens holder 902, which inhibits (if not entirely prevents) any relative movement therebetween, either rotational or axial. For example, it is envisioned that the housing 938 may be adhesively connected to the lens holder 902 and/or that the housing 938 and the lens holder 902 may be connected via one or more mechanical fasteners (e.g., one or more screws, pins, rivets, clips, etc.). Embodiments in which the optical group 904 may be removably connected to the lens holder 902 are also envisioned herein, however, would not be beyond the scope of the present disclosure.

The lens barrel 908 is positioned (located, housed, accommodated) within (is received by) the lens holder 902 in concentric relation thereto and includes respective inner and outer (first and second) ends 946, 948. More specifically, the inner end 946 of the lens barrel 908 defines a (first) transverse cross-sectional dimension D3 and is configured for insertion into the outer end 926 of the lens holder 902 (e.g., the outer chamber 932), and the outer end 948 of the lens barrel 908 defines a (second) transverse cross-sectional dimension D4 and includes an outer wall 950 with an (external) threaded portion 952. The transverse cross-sectional dimension D4 exceeds the transverse cross-sectional dimension D3, which attributes a stepped (or tapered) outer profile (contour) 954 to the lens barrel 908 that corresponds to an inner profile (contour) 956 defined by the lens holder 902, which facilitates assembly of the optical module 900 and reduces the overall dimensions thereof. The lens barrel 908 defines a chamber 958, which is configured to receive (accommodate) the optical group 914, and a (central) aperture 960, which allows light received by the optical group 914 to pass through the lens barrel 908 to the optical groups 904, 808.

The adjustment member 910 extends about, and is positioned externally of, the lens barrel 908 in concentric relation thereto, and includes a (tubular) body portion 962 that defines a (central) aperture 964, which allows light to pass therethrough and into the optical group 914. The body portion 962 includes an outer wall 966 with one or more (radial) flanges 968, 970 and one or more tactile members 972, 974 that extend (radially) outward therefrom (e.g., away from the optical axis X) and externally of the mounting member 600 such that the tactile members 972, 974 are (manually) engageable by a user.

Although shown as including a pair of flanges 968, 970 and a pair of tactile members 972, 974 in the illustrated embodiment, it is envisioned that the particular number of flanges 968, 970 and/or tactile members 972, 974 may be altered in various embodiments without departing from the scope of the present disclosure. For example, embodiments of the adjustment member 910 including a single flange (e.g., the flange 968 or the flange 970) are envisioned herein, as are embodiments including a single tactile member (e.g., the tactile member 972 or the tactile member 974), which may extend (circumferentially) about the adjustment member 910 so as to define a collar.

The adjustment member 910 is configured for rotation about an axis of rotation R1 (FIG. 6), which extends in (generally) parallel relation to (e.g., is coincident with) the optical axis X, and includes an (internal) threaded portion 976 (FIG. 7), which is located on an inner wall 978 of the body portion 962. The threaded portion 976 corresponds to, and engages, the (external) threaded portion 952 on the outer wall 950 of the lens barrel 908, whereby the adjustment member 910 and the lens barrel 908 are threadably engaged. As a result, rotation of the adjustment member 910 (e.g., via the (manual) application of force to the tactile members 972, 974) about the axis of rotation R1 (and the optical axis X) causes axial movement (translation) of the lens barrel 908 along the optical axis X (e.g., in relation to the lens holder 902, the optical group 904, and the optical group 808), which effectuates corresponding, concomitant movement of the optical group 914, thereby facilitating adjustment in the focus of the optical assembly 700 and the image capture device 400. The optical module 900 is thus reconfigurable between the short-range configuration (FIG. 9) and the long-range configuration (FIG. 10).

In the short-range configuration, the optical group 914 is spaced a (first, greater) distance Y1 from the optical group 904, which allows the optical module 900 to focus upon an object that is spaced up to a threshold distance. In the long-range configuration, the optical group 914 is spaced a (second, lesser) distance Y2 from the optical group 904, which allows the optical module 900 to focus upon an object that is spaced beyond the threshold distance.

In the illustrated embodiment, the optical module 900 is configured such that the threshold distance lies (substantially) within the range of (approximately) 25 cm to (approximately) 100 cm. Embodiments in which the threshold distance may lie outside of the disclosed range are also envisioned herein (e.g., depending upon the number and/or the configuration of the lenses 810, 906, 916), however, and would not be beyond the scope of the present disclosure, as are embodiments in which the optical module 900 may be configured to focus upon an object located beyond the threshold distance in the short-range configuration and an object located within the threshold distance in the long-range configuration.

In the illustrated embodiment, the lens barrel 908 and the adjustment member 910 (e.g., the corresponding respective threaded portions 952, 976) are configured such that, during reconfiguration of the optical module 900 between the short-range configuration and the long-range configuration, the adjustment member 910 is movable through an angular (rotational) range of motion that lies (substantially) within the range of (approximately) 30 degrees to (approximately) 90 degrees and such that that the lens barrel 908 is movable through an axial (linear) range of motion that lies substantially within the range of (approximately) 100 microns to (approximately) 1 mm. Embodiments in which the respective angular and axial ranges of motion for the adjustment member 910 and the lens barrel 908 may deviate from those disclosed are also envisioned herein (e.g., depending upon the particular configuration and/or pitch of the threaded portions 952, 976), however, and would not be beyond the scope of the present disclosure.

In certain embodiments, it is envisioned that the optical module 900 may be configured to define one or more pre-set (discrete) focus positions. For example, it is envisioned that the lens barrel 908 and the adjustment member 910 may include one or more corresponding indexing members (e.g., detents and recesses, ribs and slots, etc.) that are configured for engagement (contact) such that, upon angular (rotational) alignment of the indexing members, the lens barrel 908 and the adjustment member 910 are maintained in a fixed axial and angular (rotational) orientations, respectively. In such embodiments, it is envisioned that the indexing members may be configured to provide the user with tactile and/or audible feedback upon successful engagement, thereby indicating to the user that changes in focus positions have been successfully executed.

Although generally illustrated and described as being manually operated, embodiments are also envisioned in which operation of the focus adjustment mechanism 920 (e.g., the lens barrel 908 and the adjustment member 910) may be governed by a (motorized) actuator 980, as seen in FIG. 11. For example, it is envisioned that the actuator 980 may be configured to automatically rotate the adjustment member 910 and thereby displace the lens barrel 908 and the optical group 914 along the optical axis X to re-focus the optical module 900 (and the image capture device 400 (FIG. 4)) and/or that focus adjustment may be regulated via input from an application on a wireless device that is in communication with the actuator 980.

In order to inhibit (if not entirely prevent) rotation of the lens barrel 908 and, thus, the optical group 914, during focus adjustment, the lens holder 902 and the lens barrel 908 include corresponding (male and female) anti-rotation features 982, 984, respectively, which engage one another so as to limit (confine) the lens barrel 908 and the optical group 914 to linear motion (e.g., along the optical axis X). Limiting the optical group 914 to linear motion maintains tilt of the optical group 914, centration between the optical groups 808, 904, 914, and calibration of the optical module 900 (and the optical assembly 700), thereby inhibiting (if not entirely preventing) image distortion (or other such reductions in image quality including lack of sharpness, image shift, image blur, inconsistent contrast, etc.) that may otherwise occur.

In the illustrated embodiment, the anti-rotation feature 982 on the lens holder 902 includes one or more projections 986 (e.g., detents), and the anti-rotation feature 984 on the lens barrel 908 includes one or more corresponding recesses 988 (e.g., slots) that are configured to receive the projection(s) 986. Embodiments in which the configurations of the anti-rotation features 982, 984 may be reversed (e.g., embodiments in which the lens holder 902 may include the recess(es) 988 and the lens barrel 908 may include the projection(s) 986) are also envisioned herein, however, and would not be beyond the scope of the present disclosure.

As seen in FIGS. 5 and 6, the adjustment member 910 engages (is received) by the lens holder 902 such that the second lens holder 902 inhibits (if not entirely prevents) axial movement of the adjustment member 910 along the optical axis X during focus adjustment (e.g., rotation of the adjustment member 910). More specifically, the flanges 968, 970 on the outer wall 966 of the adjustment member 910 extend into and are respectively received by the channels 934, 936 that are defined by the outer end 926 of the lens holder 902, which constrains the adjustment member 910 and (generally) confines the adjustment member 910 to rotational movement during focus adjustment.

As seen in FIG. 13, the flange 970 is configured for engagement with an inner wall 990 of the channel 936 so as to provide a (first) hard stop 992. The hard stop 992 defines one end of the angular range of motion for the adjustment member 910 and limits rotation thereof in a first direction 1 (and, thus, corresponding axial movement of the lens barrel 908). Rotation of the adjustment member 910 in an opposite, second direction 2 (and, thus, corresponding axial movement of the lens barrel 908), is limited by a (second) hard stop 502 (FIG. 5), which is provided via engagement between the adjustment member 910 and the cover 500 and defines the other end of the angular range of motion for the adjustment member 910.

In certain embodiments, the optical module 900 may further include a locking member 994 (FIG. 6), which is supported by the adjustment member 910. It should be appreciated, however, that embodiments of the optical module 900 that are devoid of the locking member 994 are also envisioned herein, however, as shown in FIG. 5, for example, and would not be beyond the scope of the present disclosure.

The locking member 994 extends into and through the adjustment member 910 and is configured for selective engagement with the lens barrel 908 to secure the axial position thereof and thereby inhibit (if not entirely prevent) axial movement of the lens barrel 908 and, thus, the optical group 914, along the optical axis X (e.g., in order to maintain focus of the optical module 900). For example, in illustrated embodiment, the locking member 994 is configured for rotation between an unlocked (disengaged) position, in which the locking member 994 is disengaged (separated) from the lens barrel 908 such that the lens barrel 908 is axially movable along the optical axis X (e.g., in relation to the lens holder 902 and the adjustment member 910), and a locked (engaged) position, in which the locking member 994 engages (contacts) the lens barrel 908 to thereby fix the axial position of the lens barrel 908.

In certain embodiments of the present disclosure, it is envisioned that the locking member 994 may also function as a handle 996 that can be utilized to (manually) apply force to the adjustment member 910 in order to rotate the adjustment member 910 and thereby adjust focus of the optical module 900 (and the image capture device 400) in the manner described above.

In certain embodiments, such as that which is illustrated, the adjustment member 910 includes one or more sealing members 998 (e.g., O-rings, gaskets, etc.) that are configured to seal the optical module 900 in relation to the mounting member 600 and/or the cover 500 in order to inhibit (if not entirely prevent) the entry of dust, debris, water, etc., into the optical module 900 and/or the image capture device 400. More specifically, in the illustrated embodiment, the adjustment member 910 includes an inner (first) sealing member 998i that is configured for sealing engagement (contact) with the mounting member 600 and an outer (second) sealing member 998ii that is configured for sealing engagement (contact) with the cover 500.

As indicated above, the optical group 914 is supported by (e.g., secured, connected to) the lens barrel 908 such that axial movement of the lens barrel 908 along the optical axis X causes corresponding, concomitant movement of the optical group 914. In order to secure the optical group 914 within the optical module 900, the optical module 900 includes the aforementioned retainer 918 (FIG. 7), which is configured for engagement with the lens barrel 908. Although shown as being threadably engaged to the lens barrel 908, embodiments are also envisioned in which the retainer 918 and the lens barrel 908 may be adhesively secured together, as are embodiments in which the retainer 918 and the lens barrel 908 may be connected via one or more mechanical fasteners (e.g., one or more screws, pins, rivets, clips, etc.).

With reference now to FIGS. 4-13, use and operation of the optical assembly 700 will be discussed during focus adjustment of the image capture device 400.

With the optical module 900 connected to the image capture device 400 (e.g., via engagement of the lens holder 902 and the mounting member 600), the adjustment member 910 is rotated (about the axis of rotation R1 and the optical axis X) via the application of force thereto (e.g., via the tactile members 972, 974 (FIGS. 5, 6), via the locking member 994, via the actuator 980 (FIG. 11), etc.). As a result of the engagement between the corresponding threaded portions 952, 976 (FIG. 12) respectively included on the lens barrel 908 and the adjustment member 910, rotation of the adjustment member 910 in the first direction 1 (FIGS. 5, 13) causes forward axial displacement of the lens barrel 908, and, thus, the optical group 914, along the optical axis X (e.g., in a forward direction 3). Forward advancement of the lens barrel 908 and the optical group 914 results in reconfiguration of the optical module 900 from the long-range configuration (FIG. 9) into the short-range configuration (FIG. 10), which improves focus on objects located within the threshold distance. Rotation of the adjustment member 910 (in the first direction 1) continues until the hard stop 992 (FIG. 13) is reached, which maximizes short-range focus of the image capture device 400.

Oppositely, rotation of the adjustment member 910 in the second direction 2 causes rearward axial displacement of the lens barrel 908, and, thus, the optical group 914, the optical axis X (e.g., in a rearward direction 4). Rearward advancement of the lens barrel 908 and the optical group 914 results in reconfiguration of the optical module 900 from the short-range configuration into the long-range configuration, which improves focus on object located beyond the threshold distance. Rotation of the adjustment member 910 (in the second direction 2) continues until the hard stop 502 (FIG. 5) is reached, which maximizes long-range focus of the image capture device 400.

Upon adjusting focus of the image capture device 400 as desired, the locking member 994 (FIG. 6) can be utilized to fix the axial positions of the lens barrel 908 and the optical module 914, and thereby maintain focus of the image capture device 400.

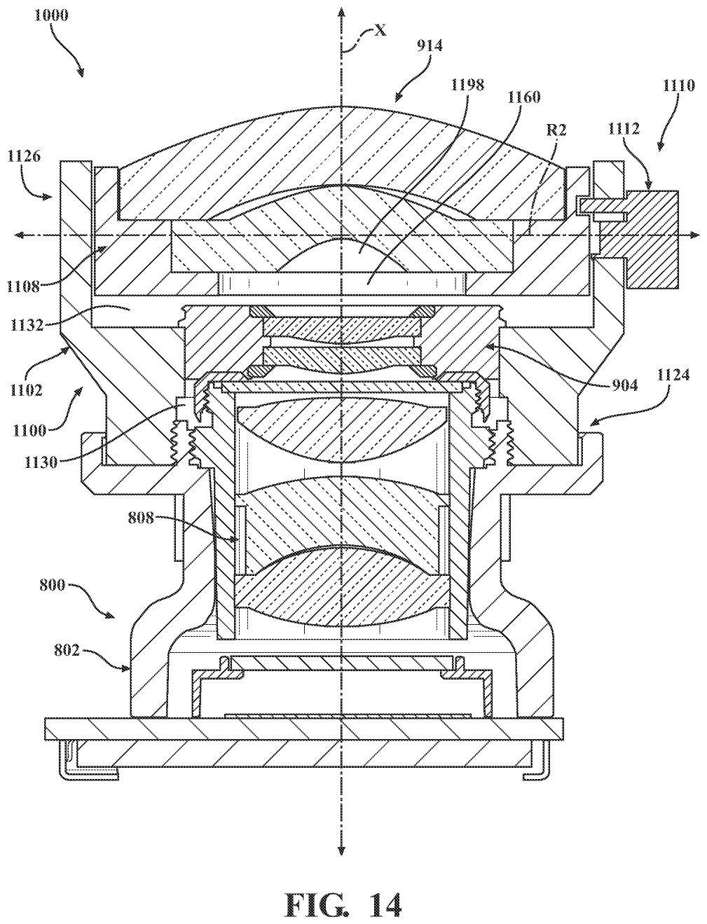

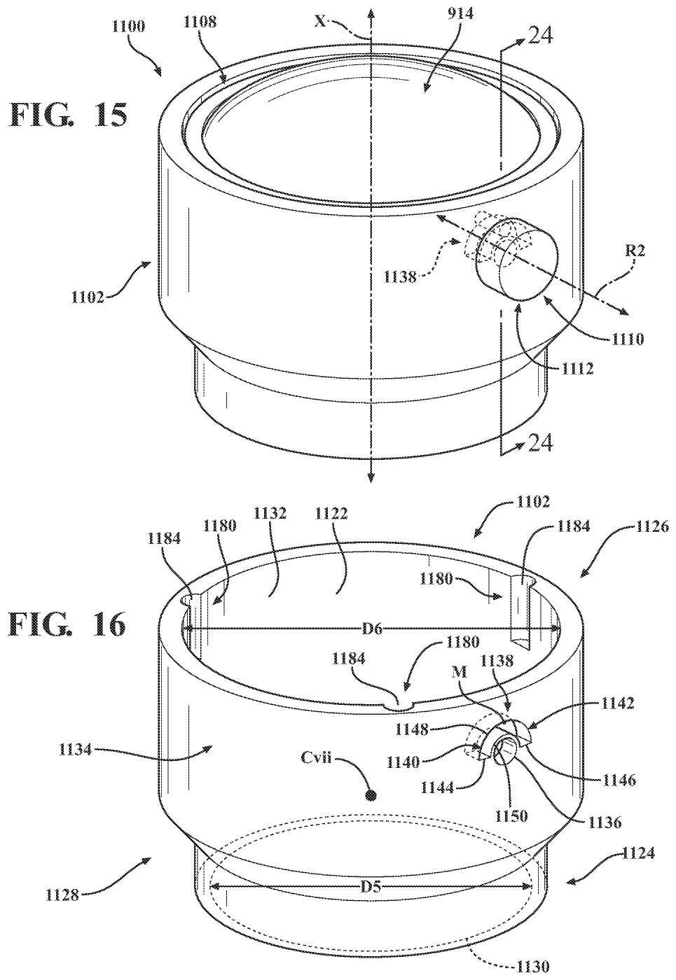

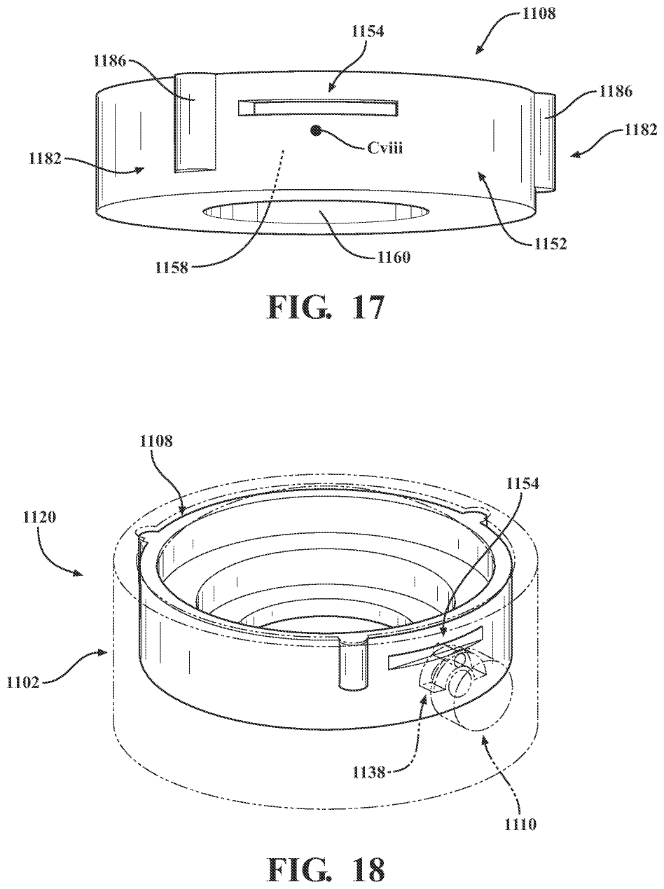

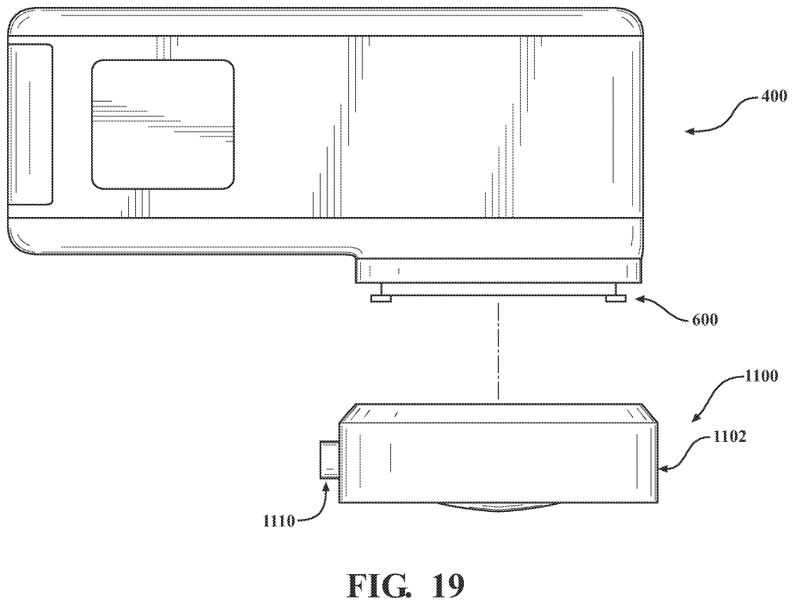

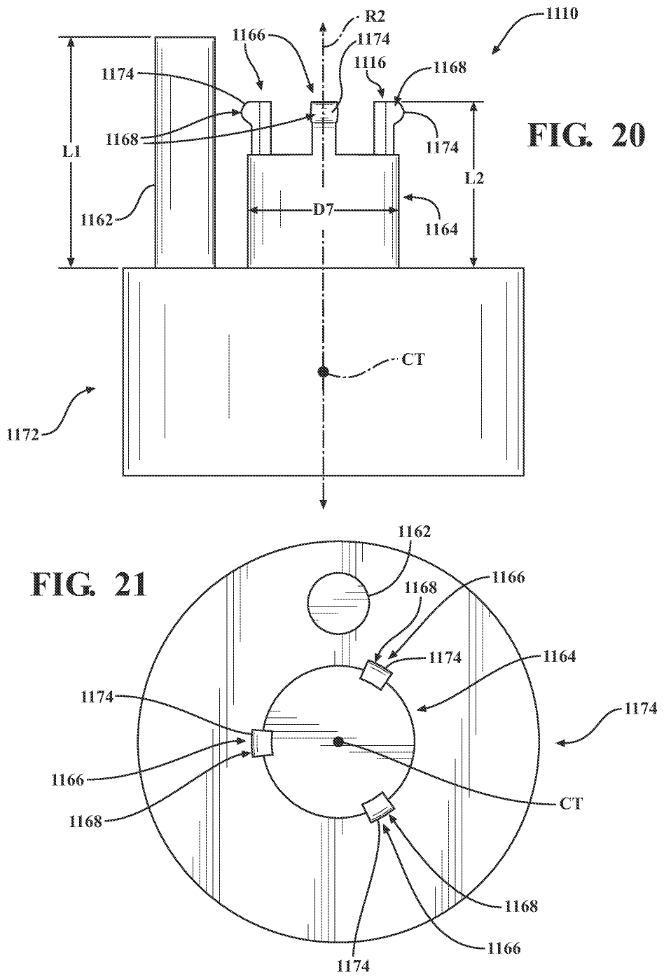

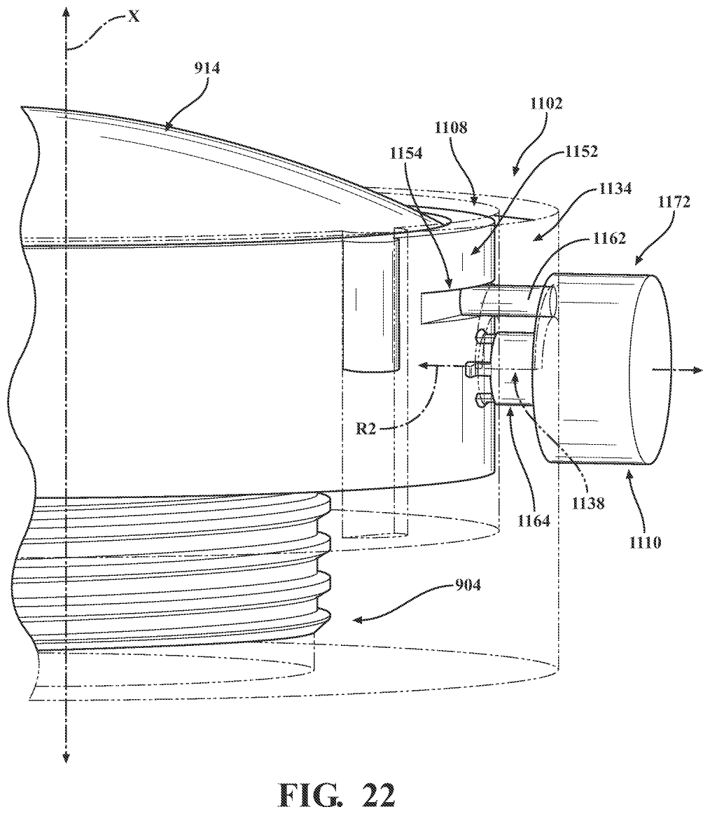

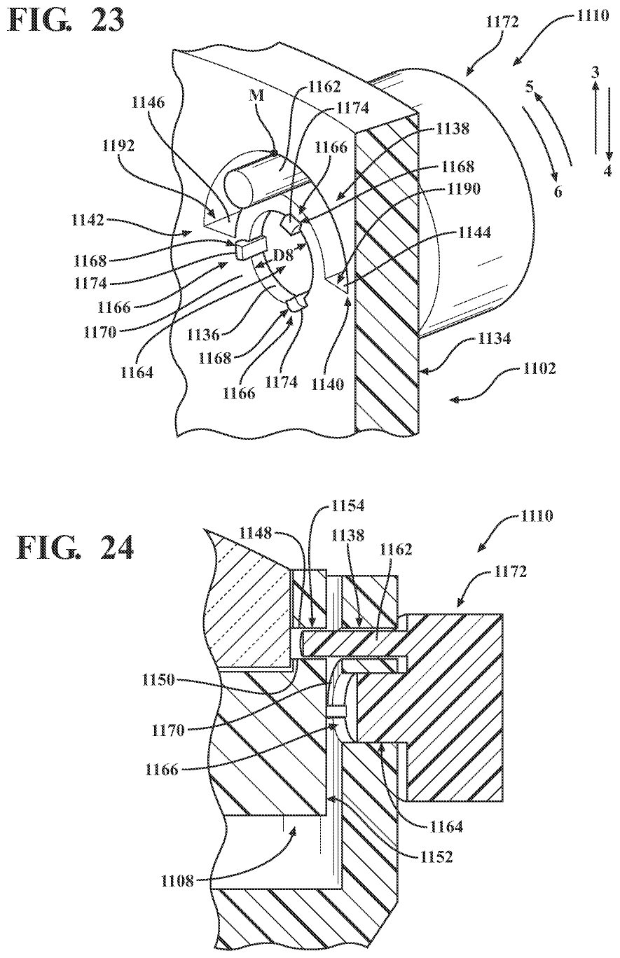

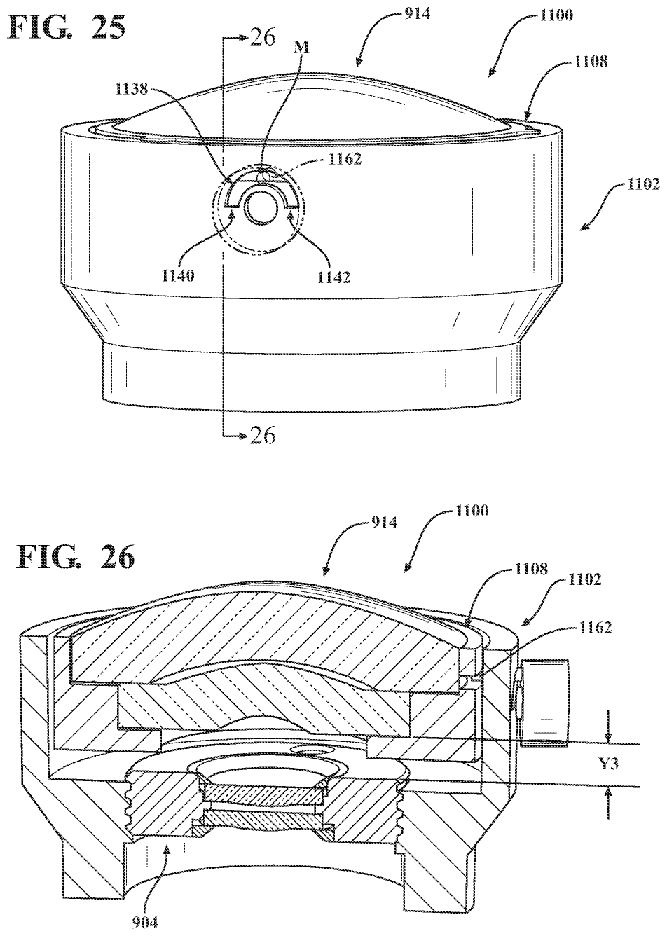

With reference now to FIGS. 14-29, an alternate embodiment of the optical assembly 700 will be discussed, which is identified by the reference character 1000 and includes the (first) optical module 800 (FIGS. 4-13) and a (second) optical module 1100. More specifically, FIG. 14 is a cross-sectional view of the optical assembly 1000; FIG. 15 is a side, perspective view of the optical module 1100, which includes: the aforedescribed optical groups 904, 914; a (second) lens holder (mount) 1102; a (second) lens barrel 1108; and an adjustment member 1110 (e.g., an adjustment knob 1112); FIG. 16 is a side, perspective view of the lens holder 1102; FIG. 17 is a side, perspective view of the lens barrel 1108; FIG. 18 is a partial, side, perspective view of the optical module 1100 illustrating the lens holder 1102 and the lens barrel 1108; FIG. 19 is a top, plan view of the image capture device 400 with the optical module 1100 shown separated therefrom; FIG. 20 is a side, plan view of the adjustment member 1110; FIG. 21 is an end, plan view of the adjustment member 1110; FIG. 22 is a partial, side, perspective view of the optical module 1100; FIG. 23 is a partial, side, perspective view of the optical module 1100 illustrating the lens holder and the adjustment member 1110; FIG. 24 is a partial, cross-sectional view of the optical module 1100 taken along line 24-24 in FIG. 15; FIG. 25 is a side, perspective view of the optical module 1100 shown in a (first, infinity) long-range configuration; FIG. 26 is a perspective, cross-sectional view of the optical module 1100 taken along line 26-26 in FIG. 25;

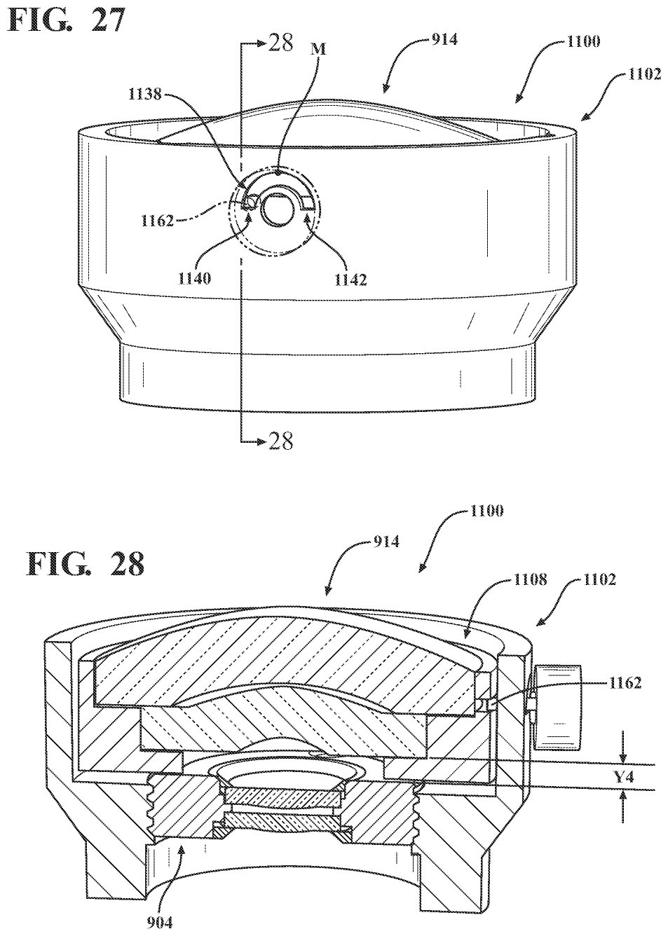

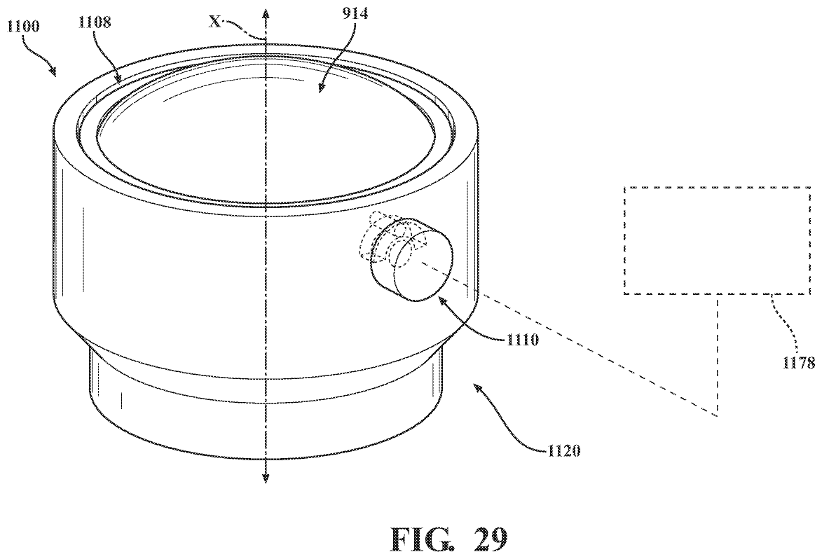

FIG. 27 is a side, perspective view of the optical module 1100 shown in a (second) short-range configuration; FIG. 28 is a perspective, cross-sectional view of the optical module 1100 taken along line 28-28 in FIG. 27; and FIG. 29 is a side, perspective view of the optical module 1100 according to an alternate embodiment of the present disclosure. The optical assembly 1000 and the optical module 1100 include features similar to the optical assembly 700 and the optical module 900 discussed above with respect to FIGS. 4-13, respectively, and, accordingly, will only be discussed with respect to differences therefrom in the interest of brevity. As such, identical reference characters will be utilized to refer to elements, structures, features, etc., common to the optical assemblies 700, 1000 and the optical modules 900, 1100.

As discussed in connection with the optical module 900, the components of the optical module 1100 (e.g., the optical groups 904, 914, the lens holder 1102; and the lens barrel 1108) are arranged concentrically along the optical axis X. More specifically, the lens holder 1102 and the lens barrel 1108 are configured such that centerpoints Cvii (FIG. 16), Cviii (FIG. 17) thereof are aligned with the centerpoints Ci-Cv (FIG. 7) of the optical groups 904, 914 along the optical axis X, respectively. Together with the adjustment member 1110, the lens holder 1102 and the lens barrel 1108 collectively provide a focus adjustment mechanism 1120 (FIG. 18) for the optical module 1100 that allows the optical module 1100 to focus on objects at various distances, as described in further detail below.

The lens holder 1102 supports each of the optical groups 904, 914, the lens barrel 1108, and the adjustment member 1110, and defines a (central) aperture 1122 (FIG. 16), which allows light received by the optical group 914 to pass through the lens holder 1102 to the optical groups 904, 808. In the illustrated embodiment, the lens holder 1102 is fixedly connected to the optical module 800 (e.g., the lens holder 802). For example, it is envisioned that the lens holder 1102 may be adhesively connected to the optical module 800 and/or that the lens holder 1102 and the optical module 800 may be connected via one or more mechanical fasteners (e.g., one or more screws, pins, rivets, clips, etc.). Embodiments are also envisioned, however, in which the lens holder 1102 may be fixedly connected to the mounting member 600 (FIG. 5), as are embodiments in which the lens holder 1102 may be removably connected to the optical module 800 (FIG. 14) or the mounting member 600 (FIG. 19) to allow for repeated connection and disconnection of the optical module 1100 to the image capture device 400 and/or replacement of the optical module 1100 with an alternate optical module having different optical qualities or features. In such embodiments of the present disclosure, it is envisioned that the optical module 1100 may thus be provided as a standalone accessory for the image capture device 400 that can be utilized to incorporate the adjustable focus described herein below, as seen in FIG. 19 and discussed in connection with the optical module 900 (FIGS. 4-13).

The lens holder 1102 includes an inner (first) end 1124, which defines a (first) transverse cross-sectional dimension D5 and is configured for connection to (e.g., insertion into) the lens holder 802 (FIG. 14) (or the mounting member 600 (FIGS. 5, 19), and an outer (second) end 1126, which defines a (second) transverse cross-sectional dimension D6. The transverse cross-sectional dimension D6 exceeds the transverse cross-sectional dimension D5 so as to attribute a stepped (or tapered) outer profile (contour) 1128 to the lens holder 1102 that corresponds to the inner profile (contour) 604 (FIG. 5) defined by mounting member 600, which facilitates assembly of the optical assembly 1000 and reduces the overall dimensions thereof, as discussed above with respect to the optical module 900 (FIGS. 4-13). The inner end 1124 defines an inner (first) chamber 1130 (FIG. 14), which is configured to receive (accommodate) the optical group 904 such that the optical group 904 is supported by the lens holder 1102 (e.g., via an adhesive connection and/or a mechanical connection therebetween), and the outer end 1126 defines an outer (second) chamber 1132, which is configured to receive (accommodate) the lens barrel 1108 and the optical group 914.

As seen in FIG. 16, the lens holder 1102 includes an outer wall 1134 with an opening 1136 and a (first) guide channel 1138, which are located at the outer end 1126 of the lens holder 1102. The opening 1136 and the guide channel 1138 extend into the outer chamber 1132 and are configured to receive the adjustment member 1110, as described in further detail below.

The guide channel 1138 is arcuate (curved) in configuration and defines opposite (first and second) ends 1140, 1142 and a midpoint M that is spaced equidistant therefrom. In the illustrated embodiment, the guide channel 1138 defines an arc that spans (approximately) 180 degrees. Embodiments of the lens holder 1102 in which the guide channel 1138 may define larger and smaller arcs are also envisioned herein, however, and would not be beyond the scope of the present disclosure. For example, the present disclosure envisions an embodiment in which the guide channel 1138 defines an arc that spans (approximately) 90 degrees.

The lens barrel 1108 is positioned (located, housed, accommodated) within (is received by) the lens holder 1102 (e.g., within the outer chamber 1132) in concentric relation thereto and defines a chamber 1158 (FIG. 14), which is configured to receive (accommodate) the optical group 914, and a (central) aperture 1160, which allows light received by the optical group 914 to pass through the lens barrel 1108 to the optical groups 904, 808. More specifically, the optical group 914 is supported within the chamber 1158 (e.g., is secured, connected to the lens barrel 1108) such that axial movement of the lens barrel 1108 along the optical axis X causes corresponding, concomitant movement of the optical group 914.

As seen in FIG. 17, the lens barrel 1108 includes an outer wall 1152 that defines a (second) guide channel 1154, which is (generally) linear in configuration and extends in (generally) orthogonal (perpendicular) relation to the optical axis X (FIG. 14). As described in further detail below, the guide channel 1154 is configured to receive the adjustment member 1110 such that the adjustment member 1110 extends through the lens holder 1102 and into engagement with the lens barrel 1108 via the respective guide channels 1138, 1154.

With reference now to FIGS. 20-24, the adjustment member 1110 will be discussed. The adjustment member 1110 is configured for rotation about an axis of rotation R2 (FIG. 22) that extends in (generally) orthogonal (perpendicular) relation to the optical axis X and engages (contacts) both the lens holder 1102 and the lens barrel 1108. As seen in FIGS. 20 and 21, the adjustment member 1110 includes a tactile member 1172, which is configured for manual engagement by a user, as well as a pin 1162 and a support shaft 1164, each of which is supported by, and extends inwardly from, the tactile member 1172 (e.g., towards the optical axis X) such that rotation of the adjustment member 1110 causes corresponding, concomitant rotation of the pin 1162 and the support shaft 1164.

The pin 1162 defines a (first) length L1 and is eccentrically located on the adjustment member 1110 such that the pin 1162 is spaced outwardly from a center point CT of the tactile member 1172. As seen in FIGS. 22-24, the pin 1162 extends through the outer wall 1134 of the lens holder 1102, and into the outer wall 1152 of the lens barrel 1108. More specifically, the pin 1162 extends through the guide channel 1138 and into the guide channel 1154 such that rotation of the adjustment member 1110 causes concomitant movement of the pin 1162 through (within) the guide channels 1138, 1154, as described in further detail below.

The support shaft 1164 extends (radially) inward from the tactile member 1172 (e.g., towards the optical axis X) and into the opening 1136 in the outer wall 1134 of the lens holder 1102. The support shaft 1164 extends in (generally) parallel relation to the pin 1162 and is spaced inwardly therefrom (e.g., further from a perimeter of the tactile member 1172). More specifically, as seen in FIGS. 20 and 21, the support shaft 1164 is aligned with the center point CT of the tactile member 1172 and thus defines the axis of rotation R2. The support shaft defines a (second) length L2, which is less than the length L1 defined by the pin 1162, and an (outer) transverse cross-sectional dimension D7, which is less than an (inner) transverse cross-sectional dimension D8 (FIG. 23) defined by the opening 1136 in the outer wall 1134 of the lens holder 1102. The reduced transverse cross-sectional dimension D7 defined by the support shaft 1164 facilitates rotation of the support shaft 1164 within the opening 1136, whereby the adjustment member 1110 is rotatable in relation to the lens holder 1102 and the lens barrel 1108 about the axis of rotation R2.

In the illustrated embodiment, the support shaft 1164 engages the lens holder 1102 in a snap (press) fit, which secures the adjustment member 1110 within the lens holder 1102. More specifically, the support shaft 1164 includes arms 1166, which (project) extend (radially) inward therefrom (e.g., towards the optical axis X). The arms 1166 include (e.g., are formed partially or entirely from) one or more resilient materials, which may be either metallic or non-metallic in construction, and define anchors 1168 that extend outwardly therefrom. The anchors 1168 are configured for engagement (contact) with an inner surface 1170 (FIGS. 23, 24) of the lens holder 1102 to thereby secure the support shaft 1164 within the opening 1136 in the outer wall 1134 and facilitate rotation of the adjustment member 1110 in relation to the lens holder 1102 and the lens barrel 1108. In order to facilitate insertion of the support shaft 1164 into the opening 1136 during connection of the adjustment member 1110 to the lens holder 1102 and assembly of the optical module 1100, the anchors 1168 define bearing surfaces 1174 which are configured for engagement (contact) with the outer wall 1134 (e.g., adjacent to a perimeter of the opening 1136) such that, during advancement of the support shaft 1164 into the opening 1136, the arms 1166 are displaced inwardly (e.g., into the opening 1136) from a normal (initial) position into a deflected (subsequent) position. As a result of the resilient material(s) used in construction of the arms 1166, during connection of the adjustment member 1110 to the lens holder 1102, a biasing force is created in the arms 1166 that automatically returns the arms 1166 to their normal positions as the bearing surfaces 1174 clear (are advanced (radially) inward beyond) the opening 1136. As the arms 1166 are returned to their normal positions, the anchors 1168 are brought into engagement (contact) with the inner surface 1170 of the lens holder 1102, thereby securing the support shaft 1164 within the opening 1136 and connecting together the adjustment member 1110 and the lens holder 1102.

During rotation of the adjustment member 1110, the pin 1162 moves through the guide channels 1138, 1154, which results in concomitant axial movement (translation) of the lens barrel 1108 and the optical group 914 along the optical axis X (FIG. 14) (e.g., in relation to the lens holder 1102, the optical group 904, and the optical group 808), thereby facilitating adjustment in the focus of the optical assembly 1000 and the image capture device 400. The optical module 1100 is thus reconfigurable between the short-range configuration (FIGS. 25, 26), in which the optical group 914 is spaced a (first, greater) distance Y3 from the optical group 904 so as to allow the optical module 1100 to focus upon an object that is spaced up to the threshold distance, and the long-range configuration (FIG. 27, 28), in which the optical group 914 is spaced a (second, lesser) distance Y4 from the optical group 904 so as to allow the optical module 1100 to focus upon an object that is spaced beyond the threshold distance.

While the optical module 1100 is configured such that the threshold distance lies substantially within the range of (approximately) 25 cm to (approximately) 100 cm, as discussed in connection with the optical module 900, embodiments are also envisioned in which the threshold distance may lie outside of the disclosed range, as are embodiments in which the optical module 1100 may be configured to focus upon an object located beyond the threshold distance in the short-range configuration and to focus upon an object located within the threshold distance in the long-range configuration.

During reconfiguration of the optical module 1100 between the short-range configuration and the long-range configuration, the adjustment member 1110 (e.g., the pin 1162) is movable through an angular (rotational) range of motion of (approximately) 180 degrees, which is defined by the arc of the guide channel 1138, and such that that the lens barrel 1108 is movable through an axial (linear) range of motion that lies substantially within the range of (approximately) 100 microns to (approximately) 1 mm. Embodiments in which the respective angular and axial ranges of motion for the adjustment member 1110 and the lens barrel 1108 may deviate from those disclosed are also envisioned herein, however, and would not be beyond the scope of the present disclosure. For example, an embodiment in which the guide channel 1138 defines an arc that spans (approximately) 90 degrees such that the adjustment member 1110 is movable through a corresponding angular range of motion is also envisioned herein, as are embodiments in which the curvature of the guide channel 1138 may be varied to thereby alter the axial range of motion for the lens barrel 1108, and would not be beyond the scope of the present disclosure.

As seen in FIG. 23, the guide channel 1138 provides hard stops 1190, 1192 at the respective ends 1140, 1142 thereof that delineate and limit the angular range of motion for the adjustment member 1110 and, thus, the axial range of motion for lens barrel 1108. More specifically, rotation of the adjustment member 1110 in a first direction 5 (e.g., clockwise), and corresponding axial movement of the lens barrel 1108 and the optical group 914, is limited by the hard stop 1192, which is provided via engagement between the pin 1162 and a (first) end wall 1144 of the guide channel 1138. Similarly, rotation of the adjustment member 1110 in a second direction 6 (e.g., counterclockwise), and corresponding axial movement of the lens barrel 1108 and the optical group 914, is limited by the hard stop 1190, which is provided via engagement between the pin 1162 and a (second) end wall 1146 of the guide channel 1138.

In certain embodiments, it is envisioned that the optical module 1100 may be configured to define one or more pre-set focus positions. For example, it is envisioned that the adjustment member 1110 may include one or more indexing members (e.g., detents, ribs, etc.) that are configured for engagement (contact) with one or more corresponding indexing members (e.g., recesses, slots) on the lens holder 1102 (e.g., within the guide channel 1138) and/or the lens barrel 1108 (e.g., within the guide channel 1154) such that, upon angular (rotational) alignment of the indexing members, the lens barrel 1108 and the adjustment member 1110 are maintained in fixed axial and angular (rotational) positions, respectively. In such embodiments, it is envisioned that the indexing members may be configured to provide the user with tactile and/or audible feedback upon successful engagement, thereby indicating to the user that the focus position has been successfully changed.

Although generally illustrated and described as being manually operated, embodiments are also envisioned in which operation of the focus adjustment mechanism 1120 may be governed by a (motorized) actuator 1178, as seen in FIG. 29. For example, it is envisioned that the actuator 1178 may be configured to automatically rotate the adjustment member 1110 and thereby displace the lens barrel 1108 and the optical group 914 along the optical axis X to re-focus the optical module 1100 (and the image capture device 400 (FIG. 4)) and/or that focus adjustment may be regulated via input from an application on a wireless device that is in communication with the actuator 1178.

In order to inhibit (if not entirely prevent) rotation of the lens barrel 1108 and, thus, the optical group 914, during focus adjustment (e.g., in relation to the lens holder 1102), the lens holder 1102 and the lens barrel 1108 include corresponding (male and female) anti-rotation features 1180, 1182, respectively, which engage one another so as to limit (confine) the lens barrel 1108 and the optical group 914 to linear motion (e.g., along the optical axis X). As discussed in connection with the optical module 900, limiting the optical group 914 to linear motion maintains tilt of the optical group 914 as well as centration between the optical groups 808, 904, 914 and calibration of the optical module 1100 (and the optical assembly 1000), thereby inhibiting (if not entirely preventing) image (or other such reductions in image quality including lack of sharpness, image shift, image blur, inconsistent contrast, etc.) that may otherwise occur.

In the illustrated embodiment, the anti-rotation feature 1180 on the lens holder 1102 includes one or more recesses 1184 (e.g., slots), and the and the anti-rotation feature 1182 on the lens barrel 1108 includes one or more corresponding projections 1186 (e.g., detents) that are configured for insertion into the recesses 1184. Embodiments in which the configurations of the anti-rotation features 1180, 1182 may be reversed (e.g., embodiments in which the lens holder 1102 may include the projection(s) 1186 and the lens barrel 1108 may include the recess(es) 1184) are also envisioned herein, however, and would not be beyond the scope of the present disclosure.

In certain embodiments, it is envisioned that the optical module 1100 may include the aforementioned locking member 994 (FIG. 6) in order to secure the axial position of the lens barrel 1108 and thereby inhibit (if not entirely prevent) axial movement of the lens barrel 1108 and, thus, the optical group 914, along the optical axis X (e.g., in order to maintain focus of the optical module 1100). For example, it is envisioned that the locking member 994 may extend into and through the lens holder 1102 such that the adjustment member 1110 is selectively engageable with and disengageable from the lens barrel 1108 via movement (e.g., rotation) between the unlocked (disengaged) position and the locked (engaged) position.

With reference now to FIGS. 14-29, use and operation of the optical assembly 1000 will be discussed during focus adjustment of the image capture device 400.

With the optical module 1100 connected to the image capture device 400 (FIGS. 4, 19) (e.g., via engagement of the lens holders 802, 1102 and the or via engagement of the lens holder 1102 and the mounting member 600), the adjustment member 1110 is rotated (about the axis of rotation R2) via the application of force thereto (e.g., manually, via the tactile member 1172, or via the actuator 1178 (FIG. 29)), whereby the pin 1162 is caused to move through the guide channels 1138, 1154 (FIGS. 22-24). Due to the eccentric location of the pin 1162 on the tactile member 1172, as the adjustment member 1110 rotates, the axial position of the pin 1162 is varied along the optical axis X. More specifically, as seen in FIG. 23, for example, rotation of the adjustment member 1110 towards the midpoint M of the guide channel 1138, in either the first direction 5 or the second direction 6, causes axial advancement (movement, translation) of the pin 1162 in the forward direction 3. Upon crossing the midpoint M, however, continued rotation of the adjustment member 1110, in either the first direction 5 or the second direction 6, causes axial retraction (movement, translation) of the pin 1162 in the rearward direction 4.

As a result of the engagement between the adjustment member 1110 and the lens barrel 1108 established via reception of the pin 1162 by the guide channel 1154, axial advancement and retraction of the pin 1162 causes corresponding axial movement (translation) of the lens barrel 1108. The guide channel 1154 thus translates angular (rotational) movement of the adjustment member 1110 into axial (linear) movement of the lens barrel 1108 and the optical group 914. More specifically, axial advancement (movement, translation) of the pin 1162 in the forward direction 3 applies force to a forward end wall 1148 (FIGS. 16, 24) of the guide channel 1138, whereby the lens barrel 1108 and the optical group 914 are displaced accordingly, thereby reconfiguring the optical module 1100 from the long-range configuration (FIGS. 27, 28) into the short-range configuration (FIGS. 25, 26), which is maximized when the pin 1162 is positioned (generally) adjacent to the midpoint M of the guide channel 1138. Conversely, axial (movement, translation) of the pin 1162 in the rearward direction 4 applies force to a rear end wall 1150 (FIGS. 16, 24) of the guide channel 1138, whereby the lens barrel 1108 and the optical group 914 are displaced accordingly, thereby reconfiguring the optical module 1100 from the short-range configuration into the long-range configuration, which is maximized when the pin 1162 is positioned (generally) adjacent to one of the ends 1140, 1142 of the guide channel 1138. As such, rotation of the adjustment member 1110 through the entire angular (rotational) range of motion defined by the arc of the guide channel 1138 results in reconfiguration of the optical module 1100 from the long-range configuration (e.g., when the pin 1162 is positioned adjacent to (towards) the end 1140 of the guide channel 1138), as seen in FIGS. 27 and 28, into the short-range configuration (e.g., when the pin 1162 is positioned adjacent to (towards) the midpoint M of the guide channel 1138), as seen in FIGS. 25 and 26, and reconfiguration of the optical module 1100 from the short-range configuration into the long-range configuration (e.g., when the pin 1162 is positioned adjacent to (towards) the end 1142 of the guide channel 1138).

Upon reaching the end of the angular range of motion in the first direction 5 (FIG. 23), the hard stop 1192 inhibits (if not entirely prevents) continued rotation of the adjustment member 1110 via engagement of the pin 1162 with the end wall 1146 of the guide channel 1138 and, thus, corresponding axial movement of the lens barrel 1108 and the optical group 914. Oppositely, upon reaching the end of the angular range of motion in the second direction 6, the hard stop 1190 inhibits (if not entirely prevents) continued rotation of the adjustment member 1110 via engagement of the pin 1162 with the end wall 1144 of the guide channel 1138 and, thus, corresponding axial movement of the lens barrel 1108 and the optical group 914.

Upon adjusting focus of the image capture device 400, the locking member 994 (FIG. 6) can be utilized to fix the axial positions of the lens barrel 1108 and the optical group 914, and thereby maintain focus of the optical module 1100 and the optical assembly 1000.

While the present disclosure has been described in connection with certain embodiments, it is to be understood that the present disclosure is not to be limited to the disclosed embodiments, but, on the contrary, is intended to cover various modifications and equivalent arrangements included within the scope of the appended claims, which scope is to be accorded the broadest interpretation so as to encompass all such modifications and equivalent structures as is permitted under the law.

Persons skilled in the art will understand that the various embodiments of the present disclosure and shown in the accompanying figures constitute non-limiting examples, and that additional components and features may be added to any of the embodiments discussed hereinabove without departing from the scope of the present disclosure. Additionally, persons skilled in the art will understand that the elements and features shown or described in connection with one embodiment may be combined with those of another embodiment without departing from the scope of the present disclosure to achieve any desired result and will appreciate further features and advantages of the presently disclosed subject matter based on the description provided. Variations, combinations, and/or modifications to any of the embodiments and/or features of the embodiments described herein that are within the abilities of a person having ordinary skill in the art are also within the scope of the present disclosure, as are alternative embodiments that may result from combining, integrating, and/or omitting features from any of the disclosed embodiments.

Use of the term “optionally” with respect to any element of a claim means that the element may be included or omitted, with both alternatives being within the scope of the claim. Additionally, use of broader terms such as “comprises,” “includes,” and “having” should be understood to provide support for narrower terms such as “consisting of,” “consisting essentially of,” and “comprised substantially of.” Accordingly, the scope of protection is not limited by the description set out above, but is defined by the claims that follow, and includes all equivalents of the subject matter of the claims.

In the preceding description, reference may be made to the spatial relationship between the various structures illustrated in the accompanying drawings, and to the spatial orientation of the structures. However, as will be recognized by those skilled in the art after a complete reading of this disclosure, the structures described herein may be positioned and oriented in any manner suitable for their intended purpose. Thus, the use of terms such as “above,” “below,” “upper,” “lower,” “inner,” “outer,” “left,” “right,” “upward,” “downward,” “inward,” “outward,” “horizontal,” “vertical,” etc., should be understood to describe a relative relationship between the structures and/or a spatial orientation of the structures. Those skilled in the art will also recognize that the use of such terms may be provided in the context of the illustrations provided by the corresponding figure(s).

Additionally, terms such as “generally,” “approximately,” “substantially,” and the like should be understood to include the numerical range, concept, or base term with which they are associated as well as variations in the numerical range, concept, or base term on the order of 25% (e.g., to allow for manufacturing tolerances and/or deviations in design). For example, the term “generally parallel” should be understood as referring to an arrangement in which the pertinent components (structures, elements) subtend an angle therebetween that is equal to 180° as well as an arrangement in which the pertinent components (structures, elements) subtend an angle therebetween that is greater than or less than 180° (e.g., +25%). The term “generally parallel” should thus be understood as encompassing configurations in which the pertinent components are arranged in parallel relation.

Although terms such as “first,” “second,” “third,” etc., may be used herein to describe various operations, elements, components, regions, and/or sections, these operations, elements, components, regions, and/or sections should not be limited by the use of these terms in that these terms are used to distinguish one operation, element, component, region, or section from another. Thus, unless expressly stated otherwise, a first operation, element, component, region, or section could be termed a second operation, element, component, region, or section without departing from the scope of the present disclosure, etc.

Each and every claim is incorporated as further disclosure into the specification and represents embodiments of the present disclosure. Also, the phrases “at least one of A, B, and C” and “A and/or B and/or C” should each be interpreted to include only A, only B, only C, or any combination of A, B, and C.

What is claimed is:

1. An optical assembly for an image capture device, the optical assembly defining an optical axis and comprising:
a first optical module including:
a first lens holder;
a first lens barrel fixed in relation to the first lens holder; and
a first optical group supported by the first lens barrel; and
a second optical module including:
a second lens holder;
a second optical group supported by the second lens holder;
a second lens barrel axially movable in relation to the second lens holder along the optical axis; and
a third optical group supported by the second lens barrel such that the third optical group is axially movable in relation to the first optical group and the second optical group along the optical axis to thereby adjust focus of the image capture device.

2. The optical assembly of claim 1, wherein the second lens holder and the second lens barrel include corresponding anti-rotation features to inhibit rotation of the second lens barrel during focus adjustment.

3. The optical assembly of claim 1, wherein the second optical module further includes an adjustment member in engagement with the second lens barrel such that such that rotation of the adjustment member causes axial movement of the second lens barrel and the third optical group along the optical axis.

4. The optical assembly of claim 3, wherein the adjustment member is configured for rotation about the optical axis.

5. The optical assembly of claim 3, wherein the adjustment member and the second lens barrel are threadably engaged.

6. The optical assembly of claim 3, wherein the adjustment member engages the second lens holder such that the second lens holder inhibits axial movement of the adjustment member along the optical axis during focus adjustment.

7. The optical assembly of claim 1, wherein the second optical module further includes an adjustment member extending through the second lens holder and into engagement with the second lens barrel such that rotation of the adjustment member causes axial movement of the second lens barrel and the third optical group along the optical axis.

8. The optical assembly of claim 7, wherein the second lens holder includes an outer wall defining an opening and a first guide channel, the adjustment member including a pin extending into the first guide channel such that rotation of the adjustment member causes movement of the pin through the first guide channel.

9. The optical assembly of claim 8, wherein the adjustment member further includes:
a tactile member configured for manual engagement by a user and supporting the pin such that the pin extends radially inward therefrom; and
a support shaft extending radially inward from the tactile member and into the opening defined by the outer wall of the second lens holder, the support shaft engaging the second lens holder in a snap fit to secure the adjustment member within the second lens holder and facilitate rotation of the adjustment member in relation thereto.

10. The optical assembly of claim 8, wherein the second lens barrel includes an outer wall defining a second guide channel, the pin extending through the first guide channel and into the second guide channel such that rotation of the adjustment member causes movement of the pin through the second guide channel.

11. An optical assembly for an image capture device, the optical assembly defining an optical axis and comprising:
an optical module including:
a lens holder;
a first optical group supported by the lens holder;
a lens barrel axially movable in relation to the lens holder along the optical axis;
a second optical group supported by the lens barrel such that the second optical group is axially movable in relation to the first optical group along the optical axis to thereby adjust focus of the image capture device; and
an adjustment member in engagement with the lens barrel such that rotation of the adjustment member causes axial movement of the lens barrel and the second optical group along the optical axis, wherein the adjustment member is configured for rotation about an axis of rotation extending in generally parallel relation to the optical axis.

12. The optical assembly of claim 11, wherein the lens holder and the lens barrel include corresponding anti-rotation features to inhibit rotation of the lens barrel during focus adjustment.

13. The optical assembly of claim 11, wherein the adjustment member threadably engages the lens barrel via corresponding threaded portions and is positioned in concentric relation thereto.

14. The optical assembly of claim 11, wherein the lens holder defines a channel and the adjustment member defines a radial flange extending into the channel such that the lens holder inhibits axial movement of the adjustment member along the optical axis during focus adjustment.

15. The optical assembly of claim 11, wherein the optical module further includes a locking member extending into the adjustment member, the locking member selectively engageable with the lens barrel to inhibit axial movement thereof along the optical axis.

16. An optical assembly for an image capture device, the optical assembly defining an optical axis and comprising:
an optical module including:
a lens holder;
a first optical group supported by the lens holder;
a lens barrel axially movable in relation to the lens holder along the optical axis;
a second optical group supported by the lens barrel such that the second optical group is axially movable in relation to the first optical group along the optical axis to thereby adjust focus of the image capture device; and
an adjustment member in engagement with the lens barrel such that rotation of the adjustment member causes axial movement of the lens barrel and the second optical group along the optical axis, wherein the adjustment member is configured for rotation about an axis of rotation extending in generally orthogonal relation to the optical axis.

17. The optical assembly of claim 16, wherein the adjustment member extends into a first guide channel defined by an outer wall of the lens holder such that rotation of the adjustment member causes movement of the adjustment member through the first guide channel.

18. The optical assembly of claim 17, wherein the adjustment member extends through the first guide channel and into a second guide channel defined by an outer wall of the lens barrel such that rotation of the adjustment member causes movement of the adjustment member through the second guide channel, whereby the lens barrel and the second optical group are displaced along the optical axis.

19. The optical assembly of claim 18, wherein the second guide channel is oriented in generally orthogonal relation to the optical axis.

20. The optical assembly of claim 18, wherein the adjustment member includes:
a pin extending into the first guide channel and the second guide channel; and
a support shaft extending in generally parallel relation to the pin and into an opening defined by the outer wall of the lens holder such that the adjustment member is rotatable in relation thereto.
